(19) United States
(12) Patent Application Publication
(10) Pub. No.: US 2009/0033155 A1
(43) Pub. Date: Feb. 5, 2009

(54) SEMICONDUCTOR INTEGRATED CIRCUITS

(75) Inventors: Yusuke KANNO, Kodaira (JP); Kenichi Yoshizumi, Fukuoka (JP)

Correspondence Address: MILES & STOCKBRIDGE PC, 1751 PINNACLE DRIVE, SUITE 500, MCLEAN, VA, 22102-3833, US

(73) Assignee: RENESAS TECHNOLOGY CORP.

(21) Appl. No.: 12/125,911

(22) Filed: May 22, 2008

(30) Foreign Application Priority Data
Jun. 8, 2007 (JP) 2007-152542
Sep. 14, 2007 (JP) 2007-239176

(51) Int. Cl. H02J 3/00

(52) U.S. Cl. 307/80

(57) ABSTRACT

A semiconductor integrated circuit includes a first power source wiring line (VDD1) for conveying a first supply voltage; a logic circuit block (CKB) which is operable by being fed with the first supply voltage; a second power source wiring line (VDD2) for propagating a second supply voltage which is higher in level than the first supply voltage; a switch (MPS) which is capable of connecting the first power source wiring line and the second power source wiring line; and a control circuit (VCTLC) which can control the switch when the first supply voltage has undergone a potential drop, so as to intermittently connect the second power source wiring line to the first power source wiring line. Owing to the control of the control circuit, a local supply voltage fluctuation is prevented, thereby to achieve the enhancement of the power source performance of the semiconductor integrated circuit. Since the enhancement of the power source performance of the semiconductor integrated circuit is achieved by the above configuration, it is unnecessary to perform a design in which the maximum operating current of an LSI chip is always met.

### CLAIM OF PRIORITY

The present application claims priority from Japanese applications JP 2007-152542 filed on Jun. 8, 2007 and JP 2007-239176 filed on Sep. 14, 2007, the content of which is hereby incorporated by reference into this application.

### FIELD OF THE INVENTION

The present invention relates to a semiconductor integrated circuit, and further to the improved technique of a power supply in the semiconductor integrated circuit, and it relates to a technique which is effective when applied to, for example, a system LSI for portable equipment.

### BACKGROUND OF THE INVENTION

In recent years, owing to the advance of semiconductor process technology, it has become possible to integrate most of required system functions on one chip. A voice processing IP (Intellectual Property) and an image processing IP, for example, are integrated together with a CPU. Such an LSI chip is called a “SoC (System-on-a-Chip). On the other hand, it has been actualized that the characteristics of individual elements constituting the LSI chip cannot be improved due to the microfication of processes. By way of example, it is mentioned that the sheet resistance of the wiring of the LSI chip increases year by year. In order to manufacture an LSI with, for example, copper, a structure called “damascene” is required as the skin of a wire material. It is pointed out that, since a proportion occupied by damascenes becomes large with the microfication of processes, the sheet resistance of the wire material increases year by year. Further, the enhancement of an information processing performance is required of each of the IPs constituting such an LSI chip, so that an operating frequency heightens year by year. Since an integrating capability has been enhanced in this manner, it has also become possible to mount a plurality of CPUs within the LSI chip, and a current consumption density has increased more than before. Accordingly, a performance degradation ascribable to a voltage drop within the LSI chip is apprehended.

[Non-patent Document 1] ‘In-situ measurement of supply-noise maps with millivolt accuracy and nanosecond-order time resolution’, Symp. on VLSI Circuit, pp. 78-79, June 2006.

[Non-patent Document 2] ‘Hierarchical Power Distribution with 20 Power Domains in 90-nm Low-Power Multi-CPU Processor’, ISSCC Dig. Tech. Paper. pp. 540-541, February 2006.

### SUMMARY OF THE INVENTION

For keeping the performance of an LSI, it has become very important to design the power source of an LSI chip. It is difficult, however, to avoid this problem by a technique for intensifying power source wiring as has hitherto been adopted. The rise of a manufacturing cost is mentioned as the reason therefor. More specifically, the increase of the total number of power source wiring lines within the LSI chip results in the addition of a new metal wiring process, so that the manufacturing cost increases. Accordingly, it is difficult to intensify the power source wiring at ease, for a consumer LSI as to which cost reduction is especially cared about. In this regard, the inventors took note of the following facts and have rearranged the problems:

(1) In an LSI called “SoC”, a plurality of CPUs and a large number of hardware accelerators are integrated on one LSI chip. The CPUs to be integrated, sometimes include one which operates at a high speed and one which operates at a low speed. From the viewpoint of power consumption, the low-speed operation CPU and hardware accelerators basically consume low power, and the high-speed CPU consumes high power. In such an LSI, accordingly, power concentration will occur only at a local part within the high-speed operation CPU. Therefore, a local power source reinforcement is effective for suppressing a cost.

(2) A recent externally-mounted power source IC often adopts a regulator circuit scheme called “switching type”, for the purpose of a higher efficiency. The regulator of this type exhibits a voltage conversion efficiency which is as high as 90% or above, and it is greatly meritorious in case of considering the reduction of the power of the whole system. However, the regulator of this type has the problem that a long time is expended on the stabilization of a control voltage. Accordingly, a dead time (about 10 microseconds) is involved in a power source control, and even when the supply voltage has lowered in the meantime, a power source circuit cannot precisely guarantee the voltage within the time period. In case of reinforcing the power source, it is one of important factors to shorten the response time.

(3) Although a SoC in recent years has remarkably enhanced its performance, a time period for which the performance is required is very short relative to the product lifetime of the SoC. By way of example, when a portable equipment is considered, telephone calls are waited for or simple business transactions are performed in most cases, and the maximum processing performance employing many graphics is required for a very short time period. Accordingly, when the SoC is designed so as to always satisfy the maximum operating current, a power source mesh within the SoC is inevitably made a lower impedance, with the result that a product design of overspecifications in the ordinary use must be performed. Thus, a countermeasure unnecessary in the ordinary use, such as the further increase of the number of wiring layers or the number of power source wiring lines is necessitated therefor. This leads to the sharp rise of a manufacturing cost.

An object of the invention is to provide a technique for enhancing the power source performance of a semiconductor integrated circuit without sharply raising a manufacturing cost.

The above and other objects and novel features of the invention will become apparent from the description of this specification when read in conjunction with the accompanying drawings.

A typical aspect of performance of the invention is briefly described as follows:

A semiconductor integrated circuit includes a first power source wiring line for conveying a first supply voltage; a logic circuit block which is operable by being fed with the first supply voltage; a second power source wiring line for propagating a second supply voltage which is higher in level than the first supply voltage; a switch which is capable of connecting the first power source wiring line and the second power source wiring line; and a control circuit which can control the switch when the first supply voltage has undergone a potential drop, so as to intermittently connect the second power source wiring line to the first power source wiring line. Owing to the control of the control circuit, a local supply voltage fluctuation is prevented, thereby to achieve the enhancement of the power source performance of the semiconductor integrated circuit. Since the enhancement of the power source performance of the semiconductor integrated circuit is achieved by the above configuration, a design in which the maximum operating current of an LSI chip is always met is dispensed with, thereby to avoid the sharp rise of a manufacturing cost.

An advantage which is brought forth by the typical aspect of performance of the invention is briefly explained as follows:

It is permitted to provide a technique for enhancing the power source performance of the semiconductor integrated circuit without sharply raising the manufacturing cost.

### BRIEF DESCRIPTION OF THE DRAWINGS

FIG. 1 is a block diagram of a configurational example of an LSI chip which exemplifies a semiconductor integrated circuit according to the present invention;

FIG. 2 is a graph for explaining the relationship between the voltage and frequency of a ring oscillator which is applied to the LSI chip;

FIG. 3 is a block diagram showing configurational examples of a voltage measurement circuit and a voltage control circuit in the LSI chip;

FIG. 4 is a diagram for explaining state shifts for performing a voltage control in the LSI chip;

FIG. 5 is a timing chart for explaining the voltage control in the LSI chip;

FIG. 6 is a diagram for explaining the voltage control in the LSI chip;

FIG. 7 is a circuit diagram of a configurational example of a voltage measurement unit in the LSI chip;

FIG. 8 is a timing chart of the operations of principal portions in the voltage measurement unit;

FIG. 9 is a circuit diagram of a configurational example of a dynamic comparator circuit in the LSI chip;

FIG. 10 is a timing chart of the operations of principal portions in the dynamic comparator circuit;

FIGS. 11A and 11B are circuit diagrams showing a configurational example of a digital control circuit in the LSI chip;

FIG. 12 is a block diagram of another configurational example of the LSI chip;

FIG. 13 is a circuit diagram of a configurational example of a level shifter which is included in the LSI chip;

FIG. 14 is a circuit diagram of another configurational example of the level shifter which is included in the LSI chip;

FIG. 15 is a circuit diagram of a configurational example of the level shifter which is included in the LSI chip;

FIG. 16 is a circuit diagram of a configurational example of the level shifter which is included in the LSI chip;

FIG. 17 is a block diagram of another configurational example of the LSI chip;

FIG. 18 is a block diagram of another configurational example of the voltage control circuit;

FIG. 19 is a circuit diagram of a configurational example in the case where a switch control in the LSI chip is performed by a plurality of switches;

FIG. 20 is a circuit diagram of a configurational example in the case where the switch control in the LSI chip is performed at a still higher precision;

FIG. 21 is a diagram for explaining a layout example of principal portions in the LSI chip;

FIG. 22 is a diagram for explaining a layout example of principal portions in the LSI chip;

FIG. 23 is a diagram for explaining a layout example of principal portions in the LSI chip;

FIG. 24 is a circuit diagram showing another configurational example of principal portions in the LSI chip;

FIG. 25 is a diagram for explaining a layout example of principal portions in the LSI chip;

FIG. 26 is a diagram for explaining a layout example of principal portions in the LSI chip;

FIG. 27 is a diagram for explaining power source closure and cutoff controls in the LSI chip;

FIG. 28 is a timing chart in the case where a thin-film switch is controlled in the LSI chip;

FIG. 29 is a flow chart showing operations in the case where a voltage control is performed in the LSI chip;

FIG. 30 is another flow chart showing operations in the case where the voltage control is performed in the LSI chip;

FIG. 31 shows an embodiment in the case where the semiconductor integrated circuit of the invention is integrated together with a hierarchic type power source cutoff mechanism;

FIG. 32 shows an embodiment for integrating the embodiment shown in FIG. 31, in an LSI;

FIG. 33 is a circuit diagram showing a region where a DVB switch, a thin-film switch and the control circuits thereof are integrated; and

FIG. 34 shows an embodiment of a layout for realizing a configuration in FIG. 33.

### DETAILED DESCRIPTION OF THE PREFERRED EMBODIMENTS

### 1. Summary of the Preferred Embodiments

First, the preferred embodiments of the present invention will be summarized. In the summary of the preferred embodiments, reference signs in the drawings as are indicated in parentheses are merely illustrative of means covered within the concepts of the corresponding constituents.

An LSI chip (SOC) according to each of the preferred embodiments of the invention includes a first supply voltage wiring line (VDD1) for conveying a first supply voltage, a logic circuit block (CKB) which can be operated by being fed with the first supply voltage, a second supply voltage wiring line (VDD2) for propagating a second supply voltage higher in level than the first supply voltage, a switch (MPS) which can connect the first supply voltage wiring line and the second supply voltage wiring line, and a control circuit (VCTLC) which can control the switch when the first supply voltage has undergone a potential drop, so as to intermittently connect the second supply voltage wiring line to the first supply voltage wiring line. Owing to the control of the control circuit, any local supply voltage fluctuation is prevented, thereby to achieve the enhancement of the power source performance of the semiconductor integrated circuit. Since the enhancement of the power source performance of the semiconductor integrated circuit is achieved by the above configuration, it is unnecessary to perform such a design that the maximum operating current of the LSI chip is always met. Therefore, the sharp rise of a manufacturing cost in the LSI chip can be suppressed. On this occasion, the control circuit can be made a circuit which has a control time constant smaller than that of a power source circuit externally mounted and which is capable of a high-speed control, and which has a high affinity with a CMOS digital process.

### 2. Further Detailed Description of the Preferred Embodiments

Next, the embodiments will be further detailed. Now, the best mode for carrying out the present invention will be described in detail in conjunction with the drawings.

Incidentally, throughout the drawings for describing the best mode for carrying out the invention, members having the same functions are assigned identical reference signs, and they shall be omitted from repeated description.

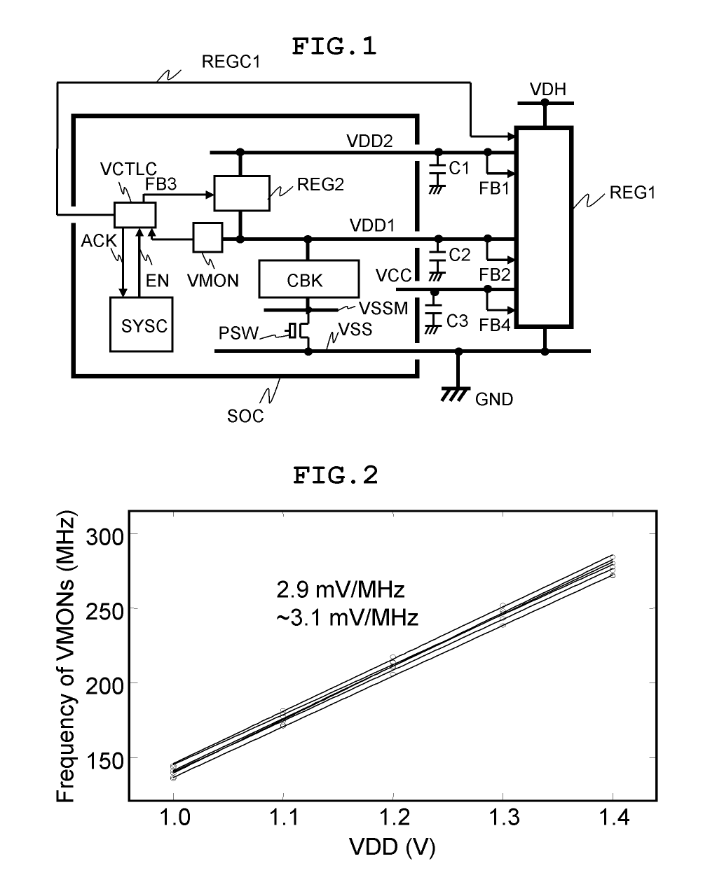

FIG. 1 shows a system LSI (hereinbelow, termed “LSI chip”) for portable equipment as is an example of a semiconductor integrated circuit according to the invention.

Although not especially limited, the LSI chip SOC shown in FIG. 1 includes a logic circuit block CBK, a system control circuit SYSC, a voltage measurement circuit VMON, a voltage control circuit VCTLC and an on-chip regulator REG2, and it is formed on one semiconductor substrate such as single-crystal silicon substrate, by known techniques for manufacturing semiconductor integrated circuits.

The logic circuit block CBK includes a CPU (central processing unit), a DSP (digital signal processor), the hardware (IPs) of an image processing function, etc., and so forth. Such a logic circuit block CBK is connected to a first supply voltage VDD1 and a ground supply voltage VSS, thereby to be operated. A power source cutoff switch mechanism PSW can cut off the supply voltage feed of the logic circuit block CBK. In a case where the logic circuit block CBK need not be operated, the supply voltage feed of this logic circuit block CBK may be cut off by the power source cutoff switch mechanism PSW. The first supply voltage VDD1 is usually generated by an off-chip regulator REG1 which is arranged outside the LSI chip SOC, so as to be fed to this LSI chip SOC. The off-chip regulator REG1 is operated by being fed with a supply voltage VDH. The reason why the off-chip regulator REG1 is located outside the LSI chip SOC, is that a power source circuit of high power source conversion efficiency is superior in cost and in performance when designed by a manufacturing process different from the manufacturing process of the LSI chip SOC. In this example, the LSI chip SOC has a second supply voltage VDD2 the voltage level of which is set higher than that of the first supply voltage VDD1 being the ordinary operating supply voltage of the LSI chip. The on-chip regulator REG2 is disposed in order to locally conduct the second supply voltage VDD2, together with the first supply voltage VDD1. The on-chip regulator REG2 has its operation controlled by the voltage measurement circuit VMON. Incidentally, a supply voltage VCC is used as a supply voltage for I/O uses in the LSI chip SOC.

A voltage measurement result (voltage information) in the voltage measurement circuit VMON is inputted to the voltage control circuit VCTLC. The voltage control circuit VCTLC processes the voltage information conveyed from the voltage measurement circuit VMON, it controls the on-chip regulator REG2 on the basis of a control signal REGC1, and it exchanges signals with the system control circuit SYSC which is capable of the general control of the LSI chip SOC. The on-chip regulator REG2 functions as a current feed circuit for returning the potential of the first supply voltage VDD1 to a desired value when it has lowered locally. The on-chip regulator REG2 operates as stated below.

(1) The supply voltage can be prevented from lowering due to a current fluctuation which is temporally momentary. In this case, it is assumed that the control time constant of the off-chip regulator REG1 is longer than that of the on-chip regulator REG2. Accordingly, a dead time (of about 10 microseconds) is involved in the supply voltage control, and a power source circuit cannot accurately ensure the voltage within the period even when the supply voltage has lowered in the meantime. In such a case, when the configuration of this example is adopted, a current is fed from the second supply voltage VDD2 higher in voltage than the first supply voltage VDD1, upon detecting the voltage fluctuation within the LSI chip SOC. Thus, the voltage lowering of the first supply voltage VDD1 can be avoided. The time constant of the on-chip regulator REG2 can be made sufficiently smaller than that of the off-chip regulator REG1.

(2) When a current is assumed in excess of an allowable current quantity at the design of a power source, current feed can be assisted. Usually, in the design of an LSI chip, an allowable current is computed at the beginning of the design, and the main line of the power source is so designed that the current can be fed. However, although the performance of the LSI chip has been remarkably enhanced in recent years, a time period for which the performance is required is much shorter than the product lifetime of the LSI chip. By way of example, when a portable equipment is considered, telephone calls are waited for or simple business transactions are performed in most cases, and the maximum processing performance employing many graphics is required for a very short time period. Accordingly, when the whole LSI chip is designed so as to satisfy the maximum operating current, a power source mesh within the LSI chip is inevitably made a lower impedance, and a countermeasure such as the further increase of the number of wiring layers or the number of power source lines is necessitated therefor. This leads to the rise of a manufacturing cost.

In contrast, according to this example, the cost increase as stated above can be minimized. More specifically, in case of a high supply voltage, even when a voltage drop occurring midway is enlarged, a desired voltage can be applied at a desired circuit portion. Therefore, a power source line of high voltage may be enlarged in a wiring resistance as compared with a power source line of low voltage. The increase of power consumption is considered as a demerit in the case of employing the high supply voltage. Since, however, an effective time period for which a high performance is required is short, the influence of the power consumption increase can be made slight. A plurality of logic circuit blocks (CKB) as stated above can be included in the LSI chip SOC. Especially in case of considering a multi-core configuration in which a plurality of CPUs are integrated, a plurality of current consumption spots appear on one LSI chip SOC. It is also possible to mount a plurality of on-chip regulators REG2 on the LSI chip SOC. Besides, when the logic circuit block CKB is used conjointly with the power source cutoff switch mechanism PSW of on-chip scheme, it can contribute to the lowering of the leakage of the LSI chip for the portable equipment.

As stated above, the on-chip regulator REG2 is smaller than the off-chip regulator REG1 in the time constant of the control response. Usually, the stabilization of a power source is necessary in order to enhance the power source quality of an LSI, and the disposition of capacitance elements is indispensable for the stabilization. The reason why the capacitance elements are disposed, has a deep relation with the control-response time constant of a power source circuit. The power source circuit adjusts the voltage level of the output power source by controlling a current feed quantity. Since the control is discretely performed especially in case of a switching type regulator, it cannot follow up the change of a current during the so-called “dead time” between one control period and the next control period. In a case where current consumption increases in the meantime, a voltage drop will be felt by the side of the LSI chip SOC. In order to stabilize voltages even in the meantime, therefore, capacitance elements C1, C2 and C3 are disposed so as to absorb the sudden fluctuation of the current consumption. A capacitor for such a purpose is called a “stabilizing capacitor”. The stabilizing capacitor depends intensely on the time constant of the fluctuation of a supply voltage. However, in a case where a capacitor of, for example, about 100 nF is required, it is very difficult to form the capacitor within the LSI chip. Now that the stabilizing capacitor cannot be integrated within the LSI chip, the formation of such a capacitor becomes equivalent to the disposition of a power source circuit outside the chip, in the significance of the stabilization of the power source. Accordingly, if there is not such a ground as the limitation of the number of power source feed lines from the exterior of the chip, as the specifications of the LSI chip SOC, it is meaningless to positively integrate the power source circuit on the chip. For this reason, there have not hitherto been carried out a considerable number of examples in each of which the power source circuit is integrated within the chip. However, assuming here that the response time constant of the voltage control is very short, the situation changes. More specifically, since the power source can be controlled at a high speed, the dead time of the voltage control shortens, and the stabilization of the power source can be realized without employing the stabilizing capacitor or the like passive element. Especially a digital circuit has the merit that minute noise such as a voltage ripple does not considerably influence the performance if it lies within a design range. Using this merit, the performance of the logic circuit can be maintained by controlling the supply voltage at the high speed. Further, if the on-chip regulator REG2 can be realized in a circuit scheme which is easily integrated with a digital CMOS circuit process, this on-chip regulator REG2 can be disposed in any desired place within the LSI chip SOC. An LSI which is presently in the mainstream has a scheme in which supply voltages and signals are derived from the four sides of the LSI. Accordingly, the influence of voltage lowering tends to become larger at the central part of the chip than at the peripheral edge part thereof. According to this example, any circuit block capable of high-speed operation can be positively mounted even at such a chip central part.

Next, a control example of the on-chip regulator REG2 will be described.

A circuit of analog control type has heretofore been known as a power source circuit. Also in this example, a power source circuit can be configured of such an analog circuit. It is mentioned, however, that the analog circuit is difficult to be designed by a microfabrication process, and that a high-speed response control circuit is difficult to be designed using the microfabrication process. Therefore, a digital control type shall be stated here.

The voltage measurement circuit VMON will be described by employing an example which applies a ring oscillator. As is known as a “voltage-controlled oscillator”, the ring oscillator has the feature that an oscillation frequency changes in accordance with a supply voltage. According to Non-patent Document (1), the relationship of the frequency versus the voltage becomes a monotonous increase function versus the supply voltage as shown in FIG. 2. Incidentally, the axis of abscissas represents the supply voltage, and the axis of ordinates represents the frequency. The fluctuation of the supply voltage is observed on the basis of frequency information by utilizing such a relationship of the monotonous increase function versus the supply voltage, whereupon the supply voltage control is performed. This example includes means for measuring the frequency, and means for converting the measured frequency into a digital signal, and it controls the on-chip regulator REG2 on the basis of the measured frequency information.

In performing the control, it is also possible to utilize a delay which is the inverse number of the frequency. In a case where the fluctuating range of the supply voltage is limited, an error becomes small even when the relationship between the voltage and the delay time is linearly approximated, and hence, the measurement and the control can be performed at high precisions even with a simple circuit arrangement. Here, the delay time will be taken as an example.

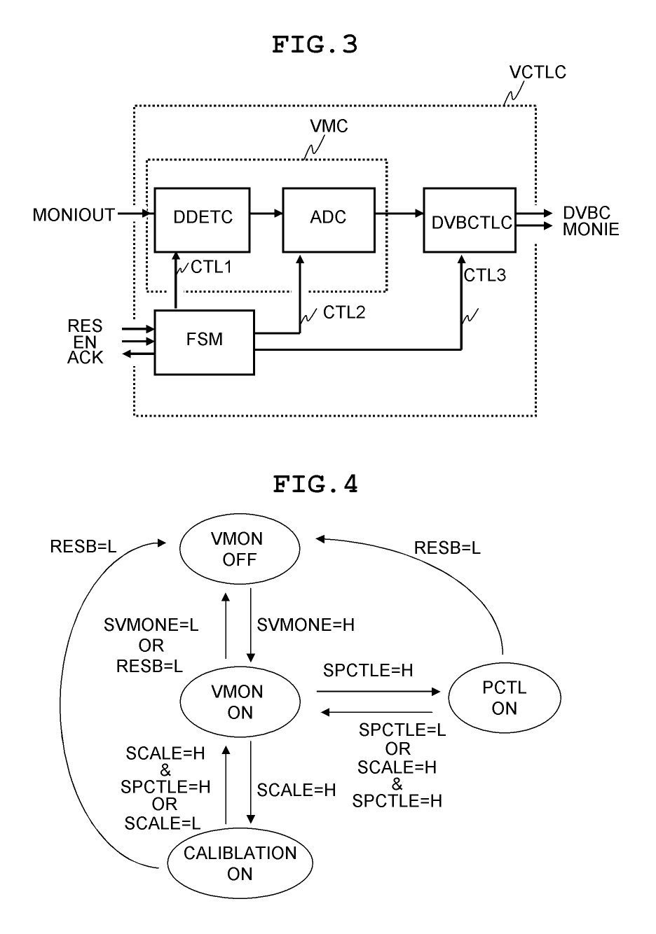

FIG. 3 shows a configurational example of the voltage control circuit VCTLC.

Although not especially limited, the voltage control circuit VCTLC is configured including a voltage measurement unit VMC, a finite state machine FSM, and a dynamic voltage boost control circuit DVBCTLC as shown in FIG. 3. Here, the on-chip power source circuit (REG2) shall be called a “dynamic voltage boost circuit” in the sense that a voltage can be dynamically changed. The voltage measurement unit VMC includes a delay measurement unit DDETC which receives an on-chip voltmeter output signal MONIOUT from the ring oscillator, so as to measure the delay time of the on-chip voltmeter output signal MONIOUT, and an analog/digital conversion unit ADC which converts the measured delay information into a digital signal. The dynamic voltage boost control circuit DVBCTLC receives the output signal from the analog/digital conversion unit ADC, so as to control a P-type MISFET included in the on-chip regulator REG2. The finite state machine FSM receives a request signal RES and an enable signal EN from the general control unit of the LSI chip SOC and delivers an acknowledge signal ACK to the general control unit, so as to control the state shifts of the delay measurement unit DDETC, analog/digital conversion unit ADC and dynamic voltage boost control circuit DVBCTLC.

FIG. 4 shows the state shifts in the control of the finite state machine FSM.

Here is supposed a case where a voltage measurement end state (VMON OFF state), a voltage measurement state (VMON ON state), a voltage control state (PCTL ON state) and a calibration state (CALB) are shifted. The calibration is necessary in order to exclude any influence ascribable to the fact that the ring oscillator type voltmeter undergoes fluctuations due to temperatures and process dispersions. In this example, the VMON OFF state is established in such a way that a reset signal (RESB) becomes a “low” (L) level. The VMON OFF state is shifted into the VMON ON state in such a way that an SVMONE signal becomes a “high” (H) level, and the VMON ON state is shifted into the calibration state in such a way that an SCALE becomes the high (H) level, while this VMON ON state is shifted into the PCTL ON state in such a way that an SPCTLE signal becomes the high (H) level. The CALIBRATION ON state is shifted into the VMON ON state in a case where the SCALE signal is at the high (H) level and where the SPCTLE signal is at the high (H) level, or in a case where the SCALE signal is at the low (L) level. The PCTL ON state is shifted into the VMON ON state in a case where the SPCTLE signal is at the low (L) level, or in a case where SCALE=H and SPCTLE=H hold.

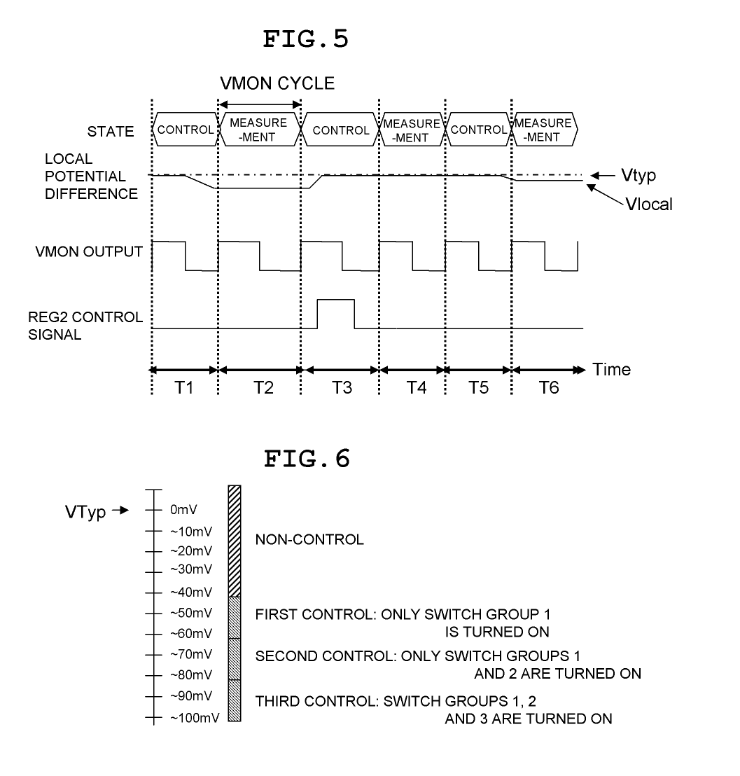

Next, the control concept of the on-chip regulator REG2 will be described with reference to FIG. 5.

FIG. 5 shows the potential difference of supply voltages connected to the voltage measurement circuit VMON for measuring the voltage (local potential difference: difference between VDD and VSS), the output waveform of the voltage measurement circuit VMON, and the control waveform of the on-chip regulator REG2.

The control of the on-chip regulator REG2 is performed by separately setting a voltage measurement period and a voltage control period. These periods are controlled in synchronism with the output signal of the voltage measurement circuit VMON. Thus, it is facilitated to sense the voltage lowering and to perform the control. The frequency of the output signal of the voltage measurement circuit VMON changes in accordance with the potential difference fluctuation of the local supply voltages, and in case of a small local potential difference, a cycle time becomes long (the frequency becomes low), whereas in case of a large local potential difference, the cycle time becomes short (the frequency becomes high). The voltage measurement circuit VMON measures how much the local potential difference Vlocal has fluctuated from the reference value Vtyp of the local power source. In this example, in a period T1, the local potential difference becomes small. In a period T2, the voltage measurement circuit VMON detects the potential difference, and the control circuit judges the control of the on-chip regulator REG2. In a period T3, the control of the on-chip regulator REG2 is performed. When the local potential difference is returned to the original level by the control of the on-chip regulator REG2 in the period T3, the cycle of the voltage measurement circuit VMON in the next period T4 is recovered, and hence, the control of the on-chip regulator REG2 is not performed in a period T5. In this manner, the potential difference measurement period and the control period for controlling the on-chip regulator REG2 on the basis of the measured potential difference are alternately performed, whereby the high-precision and high-speed control of the on-chip regulator REG2 is permitted.

In the above control method of the on-chip regulator REG2, a control concept and a circuit scheme which are simple are effective when a mounting circuit scale on the LSI is to be reduced. As one measure therefor, a threshold value control is considered. Such a control concept will be described with reference to FIG. 6. Here, the relationship between the change magnitude of the potential difference and the change magnitude of the frequency is obtained beforehand, and the control of the on-chip regulator REG2 is digitally decided with reference to a preset period change magnitude. It is also possible to set a plurality of values as the threshold values of the preset period change magnitude. It is consequently considered that, as will be stated later, supply voltage control switches are divided into a plurality of groups so as to be controlled in accordance with the voltage levels. That is, in accordance with the values, a control in which the drivability of the on-chip regulator REG2 is heightened may be performed when the potential difference is larger, and the on-chip regulator REG2 may be driven to the minimum when the potential difference is at the lowest level. With such a comparatively simple scheme, the higher precision and smaller area of the potential control can be realized. Besides, such a simple scheme contributes to the higher speed of the control. Further, in a case where a voltage drop is very large, the data of internal logics might be destroyed, thereby to hold inappropriate data. In such a case, the data retention circuit (flip-flop) of any critical signal path is dualized, and a mechanism for retaining the data of the last clock is disposed. Besides, such a control is performed that the destroyed data are discarded and that a calculation is executed again on the basis of the previous data remaining in one FF of the dualized circuit. This also brings forth the advantage that the reliability of the calculation of the LSI can be increased.

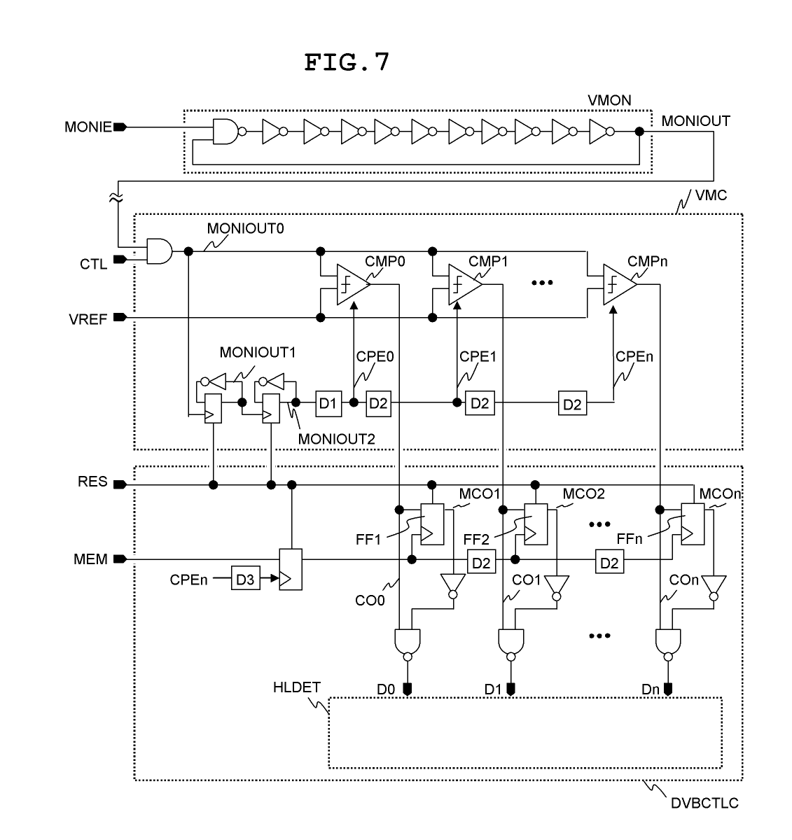

Next, a circuit arrangement in which voltage information is detected from the output signal of the voltage measurement circuit VMON, so as to control the on-chip regulator REG2, will be described with reference to FIG. 7.

FIG. 7 shows a more detailed configurational example of principal portions in FIG. 1.

The voltage measurement circuit VMON is configured by connecting an odd number of stages of inverted logic circuits, and a ring oscillator which is configured of an even number of stages of inverters and one NAND circuit is exemplified here. The oscillation of the ring oscillator and the stop of the oscillation are performed by controlling the NAND circuit with an on-chip voltmeter enable signal MONIE. The on-chip voltmeter output signal MONIOUT of the voltage measurement circuit VMON is inputted to the interior of the voltage measurement unit VMC. When a circuit for accepting the on-chip voltmeter output signal MONIOUT is made a gating circuit, for example, a NAND gate, the propagation of an indefinite signal can be avoided in a case where a power source region in which the voltage measurement circuit VMON is mounted has undergone power source cutoff. The gating of the on-chip voltmeter output signal MONIOUT is controlled by a CTL signal. The signal of the voltage measurement circuit VMON as inputted to the voltage measurement unit VMC is thereafter inputted to a delay measurement unit configured of comparator circuits CMP0 through CMPn, and an analog/digital conversion circuit unit. On this occasion, the lengths of wiring lines are equalized in order that inputs to all the comparators may become equal loads. A reference level VREF is inputted to the comparators CMP, and the output signal of the voltage measurement circuit VMON is compared with the reference level VREF. The signal of the output itself of the voltage measurement circuit VMON is used for the timings of the comparisons, and appropriate delays are added and inputted to the individual comparators through delay circuits (D1 and D2) within the voltage measurement unit VMC. In FIG. 7, flip-flops for multiplying signals to be inputted to the comparators are illustrated. They may be employed in a case where the oscillation frequency of the voltage measurement circuit VMON is high, and where a response control fails to be in time. Especially when the control is in time, the multiplying circuits are unnecessary. Output signals from the comparators become digital signals. In the circuit arrangement shown in the figure, flip-flop circuits FF0-FFn for storing the output signals from the comparators CMP0-CMPn, and logic calculation circuits (here, circuits taking logical sums with the inverted signals of stored data) are disposed, thereby to detect differences from the stored information. The outputs D0-Dn of the logic calculation circuits are conveyed to a high-level detection circuit HLDET, and are used for the detection of a high level. Delay circuits D1-D3 used here are advantageous when their sizes are somewhat enlarged, or they employ transistors of low threshold voltages, in order to afford an immunity against process dispersions.

Here, it is desirable that the voltage measurement circuit VMON is mounted in any desired place where a potential within the chip is to be measured, while the voltage measurement unit VMC is located in the vicinity of a supply voltage feed PAD which is not considerably affected by an internal potential fluctuation. Accordingly, the interval between the voltage measurement circuit VMON and the voltage measurement unit VMC becomes long in some cases. In such a case, when a repeater circuit is employed, any signal deterioration lessens. Besides, since the voltage measurement unit VMC is to exclude the influence of the noise of the power source to the utmost, it should desirably be provided with a low-pass filter or fed with the supply voltage of a system quite different from that of the internal logic circuits, from outside the chip.

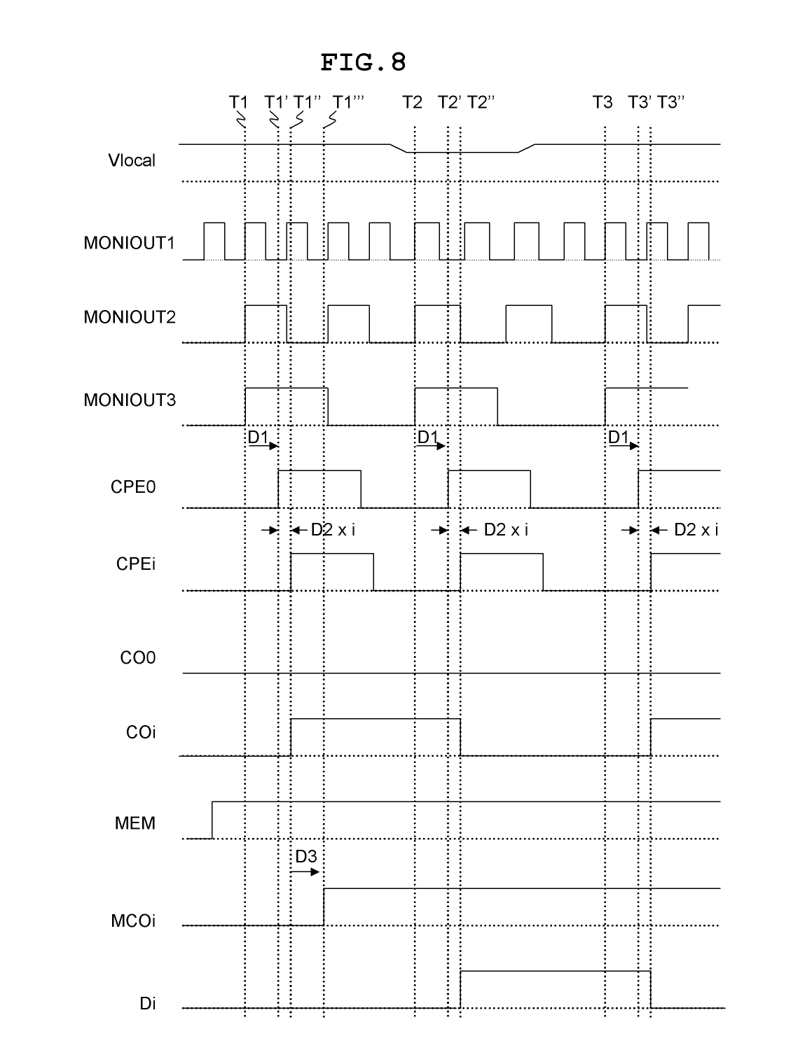

FIG. 8 shows the operating waveforms of principal portions in FIG. 7. It shows on-chip voltmeter output signals MONIOUT0-MONIOUT2, comparator enable signals CPE and comparator outputs CO. The on-chip voltmeter output signal MONIOUT1 is the ½ frequency division signal of the signal MONIOUT0, and the on-chip voltmeter output signal MONIOUT2 is the ¼ frequency division signal of the signal MONIOUT0. The rise signals of the on-chip voltmeter output signals MONIOUT1 and MONIOUT2 are synchronized with the rise of the signal MONIOUT0, and they are respectively delayed delay times inherent in the FFs. In this example, the on-chip voltmeter output signal MONIOUT2 is delayed a circuit delay time as which the comparator enable signal (CPE) has the inherent delay times D1 and D2 set in the voltage measurement unit VMC. When the delay times D1 and D2 are appropriately set, one cycle of the on-chip voltmeter output signal MONIOUT0 can be measured in synchronism with this signal MONIOUT0. When, in this manner, the comparator enable signals CPE0-CPEn gradually rise while having the inherent unit delay (D2), the respective comparators accept and output the on-chip voltmeter output signal MONIOUT0 at timings at which the delays of the unit delay D2 are added. The comparator output CO makes the comparison between the reference level VREF and the potential of the signal MONIOUT0 at the moment of the input of a signal CMONE, and the low (L) level is outputted when the on-chip voltmeter output signal MONIOUT0 is lower than the reference level VREF, whereas the high (H) level is outputted when the signal MONIOUT0 is higher. The figure illustrates an example in which, at the second rise (T2) of the on-chip voltmeter output signal MONIOUT2, the local potential difference Vlocal in the place where the voltage measurement circuit VMON is located becomes small, so that the cycle of the on-chip voltmeter output signal MONIOUT0 becomes long. In this case, when note is taken of the ith comparator output, the high (H) level is outputted at the time (T1″) of the first comparator operation, but the low (L) level is outputted at the time (T2″) of the second comparator operation. In this manner, when the circuit arrangement is employed, the cycle of the output of the voltage measurement circuit VMON can be grasped as a digital signal.

With only the above arrangement, however, there is not any information indicating which value the observed voltage has. Since a difference from a certain reference value is important for a voltage, the reference voltage information needs to be stored beforehand. This is realized by the flip-flops FF1-FFn which are controlled by a MEM signal. More specifically, when the chip is brought into a state where any potential does not fluctuate, that is, a standby state, the MEM signal is set at the high (H) level, whereby the flip-flops FF1-FFn are caused to store the values of the respective comparator outputs CO0-COn, with the on-chip voltmeter output signal MONIOUT0 as a trigger. The figure illustrates an example in which the MEM signal is set at the high (H) level before the first rise of the on-chip voltmeter output signal MONIOUT2. In this way, the data of the ith comparator output, for example, is retained at a time T1″′ which is delayed the delay time D3 from the time T1″. Since the comparator output at the time T1″′ is COi=H, MCOi=H holds. Accordingly, the output data Di=L holds. Subsequently, the case of actually measuring the voltage will be explained as to a case where the second on-chip voltmeter output signal MONIOUT2 becomes the high (H) level. At this time (time T2″), COi=L and MCOi=H hold. On the other hand, the ith comparator output COi assumes COi=L and MCOi=H when the second on-chip voltmeter output signal MONIOUT2 becomes the high (H) level. Therefore, the output data becomes Di=high (H) level. In this manner, it is permitted to detect the place where the value of the on-chip voltmeter output signal MONIOUT0 changes.

The delay time D2 corresponds to a resolution in the voltage measurement. In a case where the delay time D2 is short and where a large number of comparators can be integrated, the voltage resolution to be measured can be made small, but an area and power consumption increase. The resolution may be designed in accordance with the target value of the voltage control of the chip.

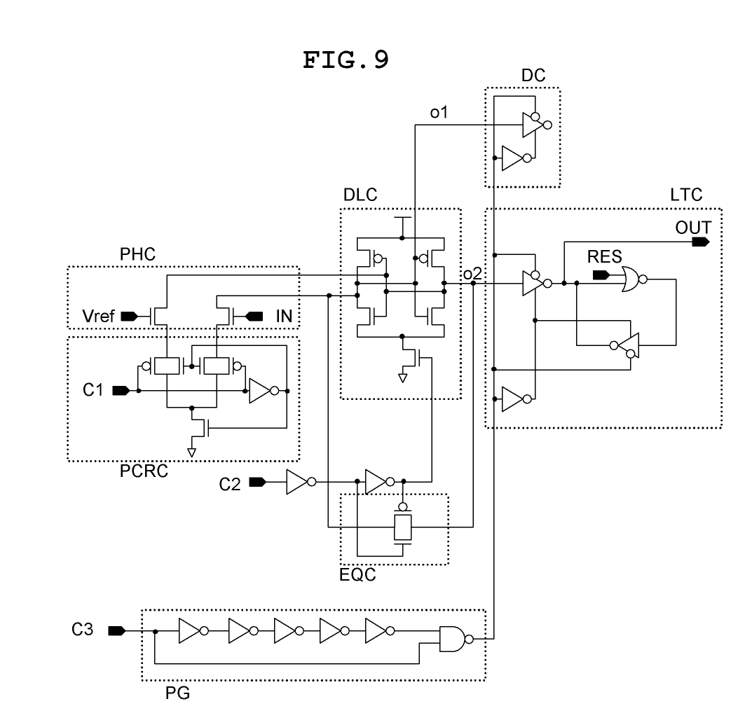

FIG. 9 shows a configurational example of a comparator which is applicable to each of the comparators CMP0-CMPn in FIG. 7.

In the case of detecting the potential difference on the chip and consequently controlling the supply voltage, only an information quantity becomes excessively large when a voltage detection precision is excessively high, and hence, a circuit arrangement in that case should desirably be simplified. Besides, a current to be consumed should desirably be low. Here will be explained a circuit arrangement with which the voltage detection precision is somewhat sacrificed, but which reduces a current consumption quantity. The exemplified comparator is configured of a differential probe head PHC by which the potential level to be detected is compared with a reference voltage Vref, a dynamic comparator circuit (DLC), a latch circuit (LTC) which holds the output signal of the dynamic comparator circuit as a digital value, an equalizer circuit EQC for the dynamic comparator circuit, and a circuit PCRC which suppresses a penetrating current flowing via the probe head. The latch circuit for the digital signal is a pulse latch which is furnished with a reset function. A pulse generation circuit PG is required for driving the pulse latch, but one pulse generation circuit suffices for a plurality of pulse latches.

The reason why the latch circuit for holding the digital value is required, is as stated below. The dynamic latch comparator measures voltages by repeating equalizing periods and estimating periods. In the equalizing period, the internal nodes o1 and o2 of a sense amplifier need to be equally set at an intermediate level. On this occasion, when an ordinary CMOS logic circuit is inputted at a succeeding state, the penetrating current flows due to the input circuit. The digital signal latch circuit is necessary for avoiding this drawback.

In this example, the pulse latch with the reset function is illustrated as the digital signal latch circuit. The reasons therefor are that a configuration of the smallest area is possible, and that a high-speed operation is possible.

Besides, it is desirable for the stable operation of the dynamic latch comparator circuit to equalize the output loads of the sense amplifier constituting this comparator circuit. In order to equalize the output loads, digital signal latches may well be added to both the nodes. In the illustration, however, a dummy circuit DC is added in order to afford the same load as that of an input circuit within the LTC, for the purpose of area reduction.

The dynamic latch comparator circuit DLC and the equalizer circuit EQC should desirably be configured of transistors of low threshold voltages. Besides, analog switches within the probe head circuit PHC and the penetrating-current suppression circuit PCRC should desirably be designed using transistors of low threshold voltages.

The penetrating-current suppression circuit PCRC cuts off a path from the node o1 to the node o2 in accordance with the C1 signal, and also cuts off a short-circuit path to a ground side. Here, an analog switch which is a combined circuit consisting of an n-channel type MOS transistor and a p-channel type MOS transistor is added to both the nodes as a cutoff circuit. This circuit is laid out to be symmetric. Thus, even if noise is generated by driving the C1 signal, the influence of the noise is canceled because the circuit PCRC is originally a differential circuit.

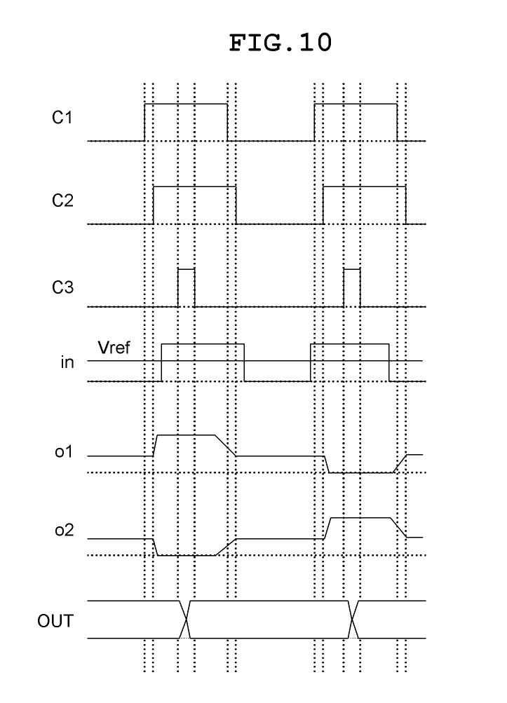

FIG. 10 shows the operating waveforms of the circuits shown in FIG. 9.

When the C1 signal has become the high (H) level, the cutoff of the penetrating-current suppression circuit by the probe circuit is performed, and the operation of the dynamic comparator circuit is started by the C2 signal. The time difference between the cutoff and the operation start is set to be very short. Then, the outputs o1 and o2 of the dynamic comparator circuit capture the signals of the high (H) level and low (L) level, respectively. Thereafter, when the digital latch circuit is activated by the C3 signal, the o1 and o2 signals can be accepted into latches. The data are held in the digital latch circuit during a precharge period.

Next, there will be explained a circuit arrangement which computes digital information from the outputs D0-Dn of the voltage measurement circuit shown in FIG. 7. As stated before, as each of the signals D0-Dn, the high (H) level is outputted only in the case where the stored data and the measured data are different. One calculation method for performing a digital control on the basis of the signals will be explained. The cycle of the voltage measurement circuit VMON changes sensitively, depending upon a device dispersion, a temperature condition and a process skew condition. The circuit arrangement needs to accept the magnitude of the change. Here will be explained the circuit arrangement in which 4 bits of the high (H) level outputs are detected from among 16 bits. In a case, for example, where the delay time of the delay circuit D2 is 100 ps in the circuit shown in FIG. 7, and where it corresponds to a voltage change of 10 mV, it is possible to detect, for example, a deviation of 400 ps, that is, a potential fluctuation of 40 mV.

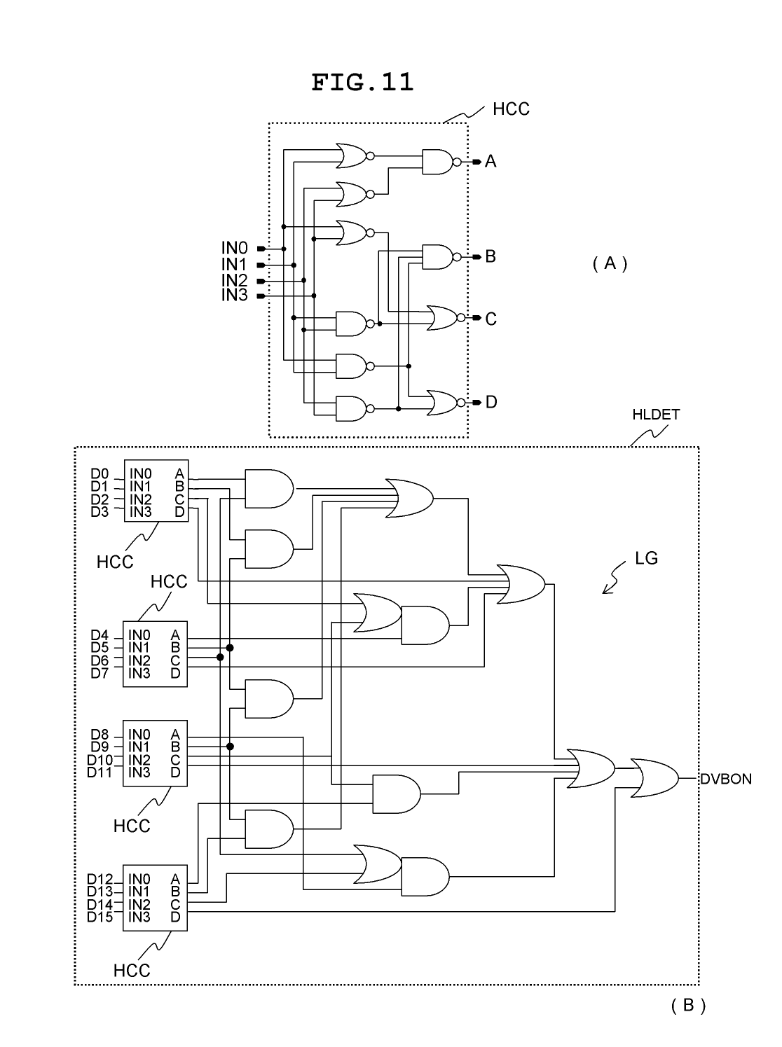

FIGS. 11A and 11B show configurational examples of a calculation circuit HCC and the high-level detection circuit HLDET, respectively.

As shown in FIG. 11A, the calculation circuit HCC is permitted to measure the number of high (H) level signals in a 4-bit signal string (IN0-IN3) by the combination of NOR gates and NAD gates. With this circuit, only an output A becomes the high (H) level in a case where any one of the signals IN0-IN3 is at the high (H) level, and outputs A and B become the high (H) level in a case where any two are at the high (H) level. Besides, outputs A, B and C become the high (H) level in a case where any three are at the high (H) level, and an output D becomes the high (H) level in a case where all are at the high (H) level.

As shown in FIG. 11B, the high-level detection circuit HLDET is permitted to detect high (H) level signals of 4 bits from the outputs D0-D15 in FIG. 7, by employing four such calculation circuits HCC. The detection results are conveyed to a logic circuit LG arranged at a succeeding stage. The logic circuit LG is configured by combining AND gates and OR gates. With such a circuit, in a case where the successive high (H) level signals of 4 bits have been detected in any place of the outputs D0-D15, an output DVBON becomes the high (H) level. Thus, it is possible to obtain a configuration which detects, for example, the potential fluctuation of 40 mV, and with which the voltage control can be performed when the potential fluctuation has become 40 mV.

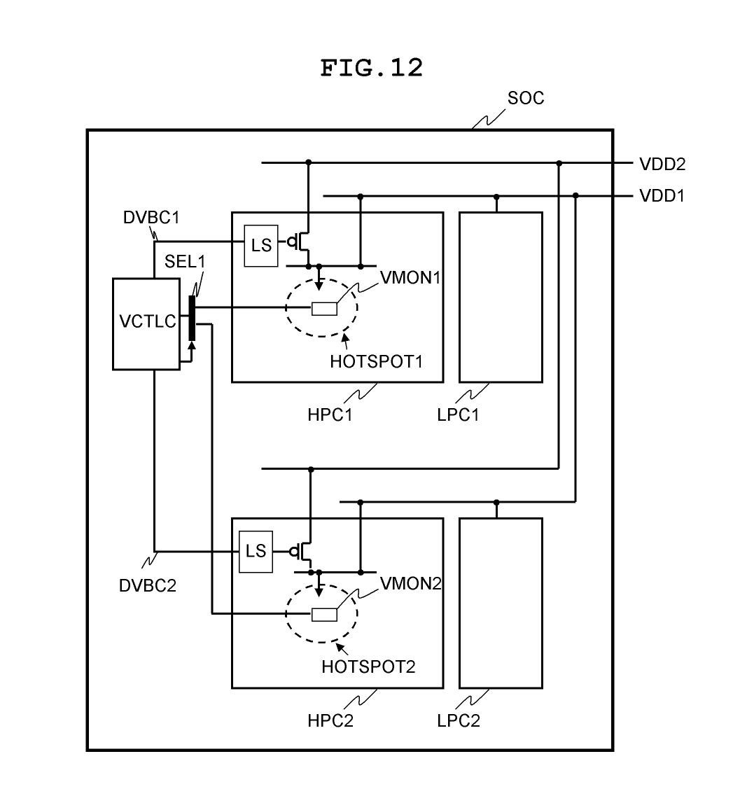

FIG. 12 shows a configurational example in the case where a plurality of voltage measurement circuits VMON as stated above are mounted within the LSI chip.

Within the chip, a plurality of high-performance circuit blocks HPC are arranged in addition to low-power circuit blocks LPC1 and LPC2. In such a case, the voltage measurement circuits VMON1 and VMON2 are respectively integrated at those parts (hot spot parts) HOTSPOT1 and HOTSPOT2 of the plurality of high-performance circuit blocks HPC at which the potential fluctuations are large. This example illustrates an example in which the voltage control circuit VCTLC is shared, with a mind to the fact that the high-performance circuit blocks HPC1 and HPC2 operate exclusively, or that either of the high-performance circuit blocks HPC1 and HPC2 operates at a high speed. In this example, the output signals of the voltage control circuit VCTLC are distributed by a selector SEL1, whereby the high-performance circuit blocks HPC1 and HPC2 operate exclusively. By the way, in a case where the high-performance circuit blocks HPC1 and HPC2 carry out equivalent high-speed operations at the same time, two such voltage control circuits VCTLC can be disposed so as to perform simultaneous controls.

Voltage information is converted into delay information by the voltage measurement circuit VMON1 and the voltage measurement circuit VMON2, and the delay information is conveyed to the voltage control circuit VCTLC. Thereafter, the delay information is converted into digital information by the voltage control circuit VCTLC, so as to perform the voltage control. Here, P-type MISFETs each of which connects the second supply voltage VDD2 and the first supply voltage VDD1 are employed as the on-chip regulator. The power source of the P-type MISFET is the supply voltage VDD2, which is higher in potential than the supply voltage VDD1. Therefore, a control potential must be a signal which operates with the second supply voltage VDD2. Accordingly, before the control signal is inputted to the P-type MISFET, a signal amplitude level is shifted from a VDD1 amplitude level into a VDD2 amplitude level by a level shifter which shifts the level of a signal amplitude.

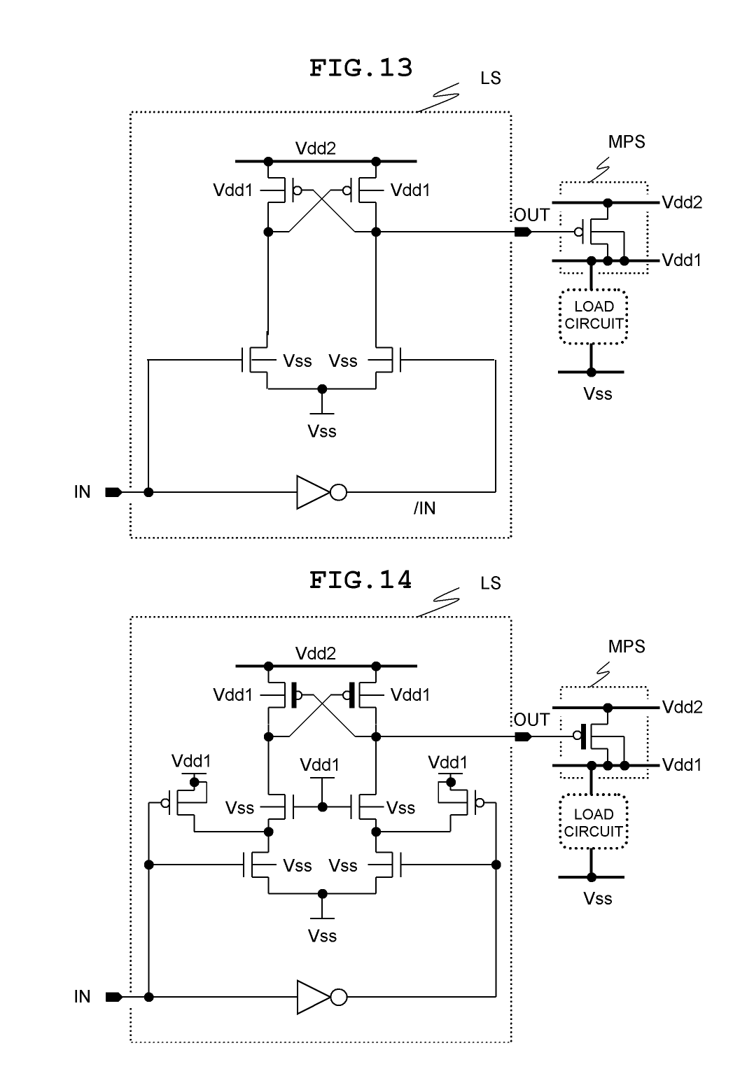

FIG. 13 shows a configurational example of the level shifter LS.

The level shifter LS is a circuit which can be used in a case where the potential difference between the supply voltages VDD1 and VDD2 is not very large, and where the supply voltage VDD2 is within the maximum withstand voltage of transistors constituting a logic circuit. This example exemplifies a case where VDD1=1.2 V and VDD2=1.4 V are set. The feature of this circuit is that the substrate potential of each of P-type MISFETs which have source potentials of the supply voltage VDD2 is the supply voltage VDD1. Also, the substrate electrode of a P-type MISFET (MPS) for a DVB control is connected to the side of the supply voltage VDD1. Thus, the increase of an area can be avoided in a case where the level shifter LS is manufactured using a bulk type CMOS process of triple well structure. In this case, a forward bias is applied to the substrate electrode of the P-type MISFET. However, in such a case where the potential difference between the supply voltages VDD1 and VDD2 is 0.2 V or the like small value, a so-called “latch-up state” where the parasitic diode of the P-type MISFET falls into an ON state is not apprehended though a substrate current flows from the VDD2 side to the VDD1 side more or less.

FIG. 14 shows another configurational example of the level shifter LS.

The level shifter LS shown in FIG. 14 can be used in a case where the potential difference between the supply voltages and VDD2 is not very large, and where the supply voltage is within the maximum withstand voltage of transistors constituting a logic circuit. This example exemplifies a case where VDD1=1.2 V and VDD2=1.5 V are set. When the voltage is directly applied to the transistors, withstand voltage breakdown occurs, and hence, a circuit for withstand voltage relaxation is disposed. In this circuit, at most the VDD2 voltage is applied to each of P-type MISFETs which have source potentials of the VDD2 voltage, and to switches each of which connects the first supply voltage VDD1 and the second supply voltage VDD2. Therefore, the transistor needs to be made of a transistor of somewhat high withstand voltage, and it should desirably be designed with a transistor for I/O uses, or with a transistor having a film thickness intermediate between those of a transistor for logic use and the transistor for I/O uses. The feature of this circuit is that the substrate potential of each of P-type MISFETs which have the source potentials of the supply voltage VDD2 is the supply voltage VDD1. Also, the substrate electrode of a P-type MISFET (MPS) for a DVB control is connected to the side of the supply voltage VDD1. Thus, the increase of an area can be avoided in a case where the level shifter LS is manufactured using a bulk type CMOS process of triple well structure. In this case, a forward bias is applied to the substrate electrode of the P-type MISFET. However, in such a case where the potential difference between the supply voltages VDD1 and VDD2 is 0.3 V or the like small value, the so-called “latch-up state” where the parasitic diode of the P-type MISFET falls into an ON state is not apprehended though a substrate current flows from the VDD2 side to the VDD1 side more or less. The latch-up is not apprehended as long as the potential difference between the supply voltages VDD1 and VDD2 does not amount to a voltage (about 0.6 V) at which the diode parasitic to the transistor turns ON.

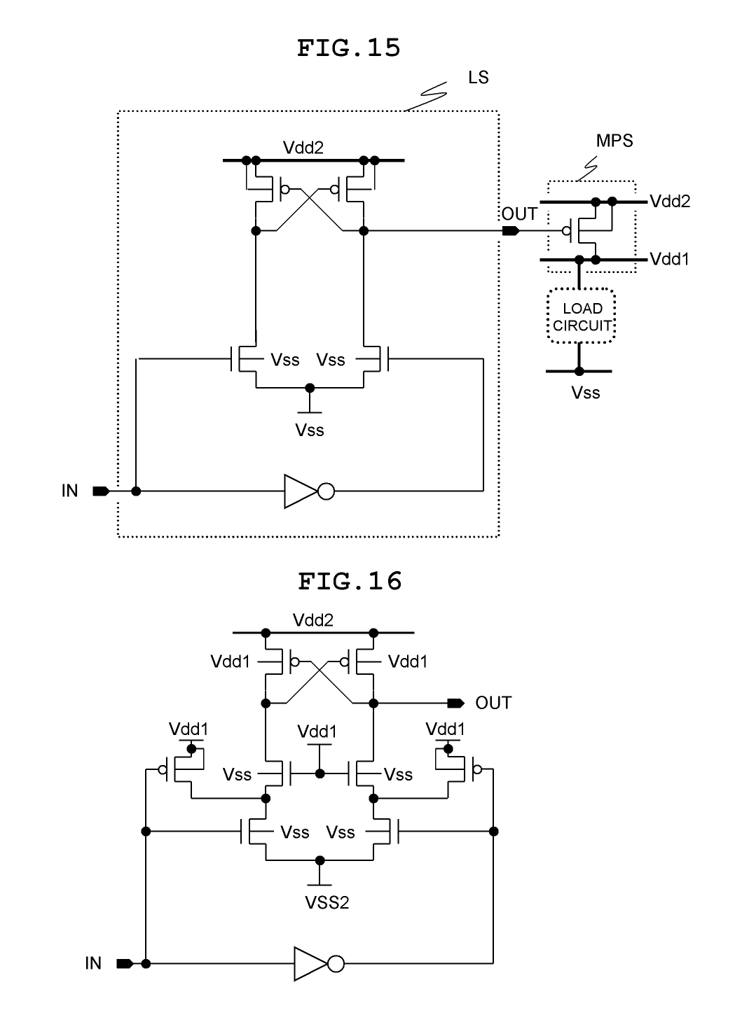

FIG. 15 shows another configurational example of the level shifter LS.

The level shifter LS shown in FIG. 15 can be used in a case where the potential difference between the supply voltages VDD1 and VDD2 is not very large, and where the supply voltage VDD2 is within the maximum withstand voltage of transistors constituting a logic circuit. This example exemplifies a case where VDD1=1.2 V and VDD2=1.4 V are set. The feature of this circuit is that the substrate potential of each of P-type MISFETs which have source potentials of the supply voltage VDD2 is the supply voltage VDD2. Also, the substrate electrode of a P-type MISFET (MPS) for a DVB control is connected to the side of the supply voltage VDD2. Thus, the increase of an area occurs in a case where the level shifter LS is manufactured using a bulk type CMOS process of triple well structure, but a configuration in which any forward bias is not applied to the substrate electrode of the P-type MISFET can be realized. In a case where the potential difference between the supply voltages VDD1 and VDD2 is large, this example is convenient for avoiding latch-up. Further, such a circuit arrangement is congenial to SOI technology. Especially in a complete depletion type SOI, the substrate electrode is separable every element. Therefore, even when this circuit scheme is adopted, the area increase is suppressed to the minimum. This scheme is also applicable to the configuration of the type in FIG. 14.

FIG. 16 shows a configurational example in the case where, even when the second supply voltage VDD2 exceeds the withstand voltages of transistors, all the transistors which constitute the level shifter and switches each serving to connect the first supply voltage VDD1 and the second supply voltage VDD2 can be made of the same thin-film transistors as those used for a logic circuit.

The reason why the transistors of thick films are employed in the configuration shown in FIG. 14, is that the gates of the transistors for connecting the first supply voltage VDD1 and the second supply voltage VDD2 are subjected to 0 V and the potential of the supply voltage VDD2. This is ascribable to the fact that the ground of the level shifter is at the 0 V. Accordingly, when the ground of the level shifter LS is set at, for example, VSS2=0.3 V for VDD1=1.2 V and VDD2=1.5 V, the output of the level shifter LS becomes a signal which shifts between 1.5 V and 0.3 V. Therefore, all the transistors constituting these circuits can be made of the transistors of the same sort as that of the transistors used in the logic circuit. Since the VSS2 potential does not require a very large consumption current, a potential rise based on a diode connection or an on-chip regulator may well be utilized for the generation of this potential.

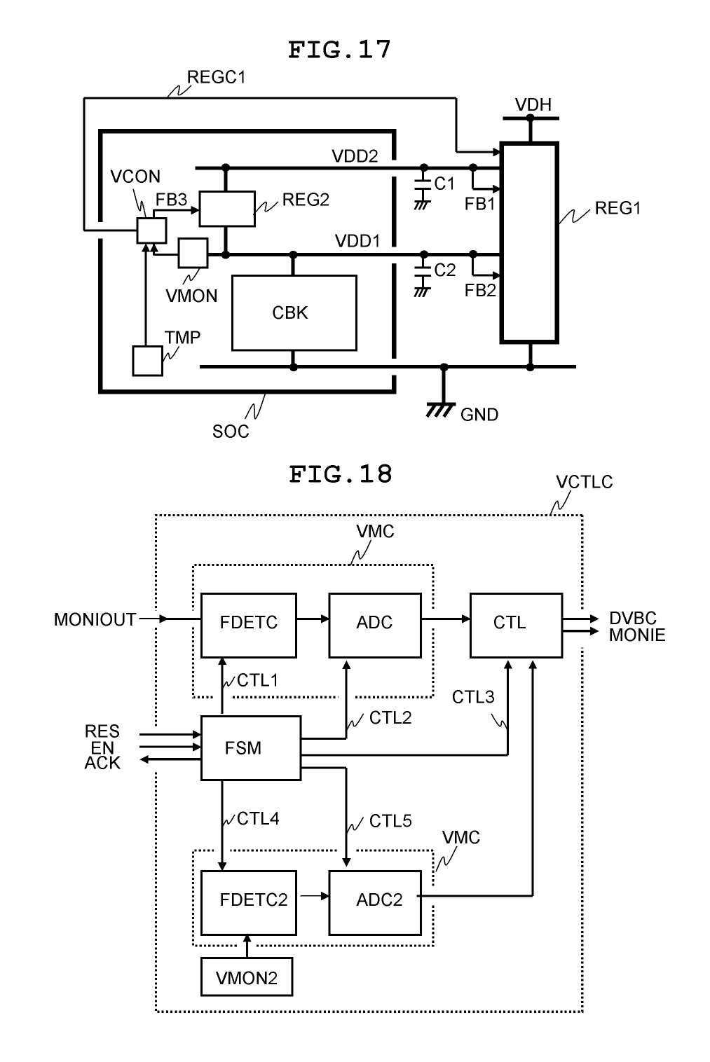

FIG. 17 shows another configurational example in the case where a temperature measurement unit is disposed within the chip.

Here, the temperature measurement unit TMP is added to the configuration shown in FIG. 1. Temperature measurement information in the temperature measurement unit TMP is transmitted to a voltage control circuit VCON, whereby a supply voltage control based on the temperature information is permitted. In a case, for example, where the temperature of the chip has become high, further heat generation is apprehended due to the high-speed operation of the circuit arrangement. In this case, when a voltage rise control is suppressed by the circuit VCON so as to suppress the heat generation, there is the advantage that the thermal runaway of the chip is avoided. On this occasion, when a high-speed operation suppression signal is conveyed to a controller for generally controlling the chip, the performance of the whole chip can be efficiently controlled. Incidentally, although no illustration is made in FIG. 17, this example is also applicable to the case of the configuration in which the power source switch shown in FIG. 1 is employed for the logic circuit block CKB, thereby to permit the control of cutoff from the true ground.

FIG. 18 shows another configurational example of the voltage control circuit. The configuration shown in FIG. 18 is greatly different from the configuration shown in FIG. 3, in the point that a voltage measurement circuit VMON is further disposed within the voltage control circuit VCTLC, whereby a local voltage fluctuation within the voltage control circuit VCTLC is also measurable. It is anticipated that a supply voltage within the chip will greatly fluctuate on account of the operation of an internal high-speed circuit block. The voltage control circuit VCTLC should desirably be mounted on the trunk part of the supply voltage feed of the chip in order to exclude the influence of the fluctuation to the utmost. Even when the circuit VCTLC is mounted in such a place, it is sometimes difficult to completely exclude the influence of a supply voltage drop such as a potential drop on a board. In that case, the exclusion of power source noise in the voltage control circuit VCTLC is required. Therefore, the voltage measurement circuit VMON is mounted within the voltage control circuit VCTLC, and the voltage fluctuation within the voltage control circuit VCTLC is monitored therein, so as to compute the influence of the fluctuation and to feed the influence back to the control. The weighted control of a delay magnitude is considered as a method for the computation. Information which is measured within the voltage control circuit VCTLC is the delay information of the voltage measurement circuit VMON integrated at a non-measurement part. The delay information is measured by a delay circuit within the voltage control circuit VCTLC, and it is used for the calibration of the delay magnitude of the delay circuit within the voltage control circuit VCTLC. By way of example, assuming that the delay of the voltage measurement circuit VMON2 within the voltage control circuit VCTLC has increased, a measurement error is computed from the information so as to apply the feedback to the control. Table lookup is convenient for the measurement because of a higher speed operation. Data in a table here may be preset at the stage of manufacture, or it is considered to sequentially compute potential fluctuations by a dedicated controller mounted on the chip and to store calibration coefficients in the table.

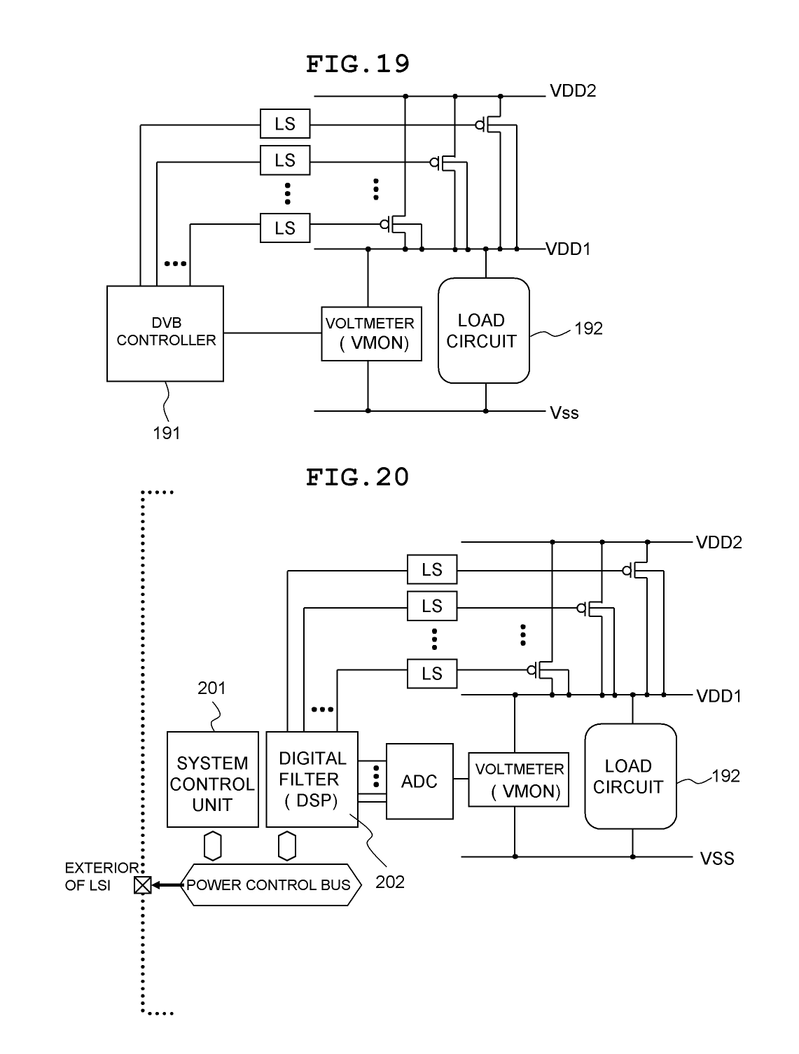

FIG. 19 shows a configurational example in which the switch for connecting the second supply voltage VDD2 and the first supply voltage VDD1 is controlled in a manner to be divided into a plurality of blocks.

A voltage control magnitude is determined by a DVB controller 191 on the basis of voltage information measured by the voltage measurement circuit VMON, and a control in which the necessary number of switches are turned ON is performed. Thus, the VDD1 potential leading to a load circuit 192 can be precisely controlled. The load circuit 192 includes the logic circuit block CKB.

FIG. 20 shows a configurational example in the case where the switch for connecting the second supply voltage VDD2 and the first supply voltage VDD1 is controlled more precisely.

In this example, a voltage measured by the voltage measurement circuit is converted into a digital signal by an analog/digital conversion circuit, and the resulting signal is calculated by a DSP (digital signal processor) 202, thereby to control a required amount of switches. Digital filtering in the DSP 202 is capable of high degree of digital signal processing, and a voltage control magnitude can be controlled at a high precision on the basis of the prediction or past history of the change magnitude of the voltage.

Besides, in a case where the cooperation of the DSP 202 with a system control unit 201 is intensified and where the control of the regulator outside the chip is performed on the basis of the information of the internal voltmeter, the enhancement of the total system performance of the LSI can be expected. A power control is performed using a power control BUS. Such an interlocked control with the regulator outside the chip is also usable together with the simple on-chip power source control scheme as shown in FIG. 7.

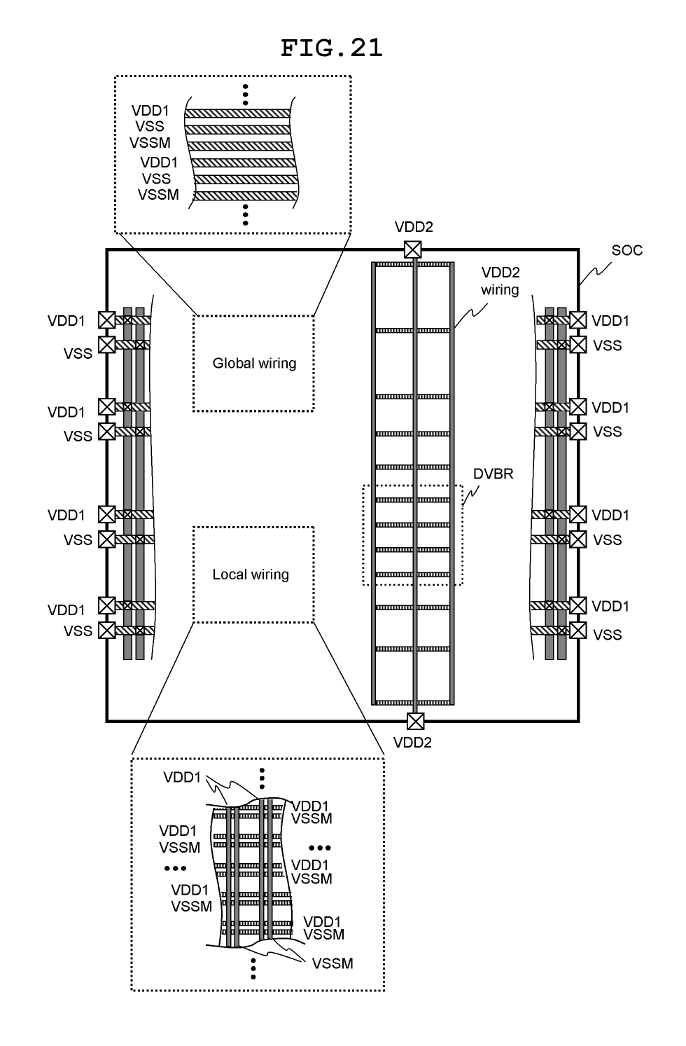

FIG. 21 shows a layout example of the LSI chip SOC.

In the LSI chip SOC, the first supply voltage VDD1 and the ground VSS are fed to the chip through a large number of pins, but the second supply voltage VDD2 higher than the first supply voltage VDD1 is fed to the LSI through a small number of pins. Here, the LSI having a global power source structure as stated in Non-patent Document (2) is supposed. In the power source structure of this type, voltages VDD and VSS and a virtual ground supply voltage VSSM through a power source cutoff switch are wired as global supply voltages and by uppermost-layer wiring lines in a lateral direction as shown in the figure. Since the first supply voltage VDD1 is the main power source of the LSI, it features low-impedance wiring. Therefore, especially the first supply voltage VDD1 and the virtual ground supply voltage VSSM are wired in mesh shapes by employing the lower metal wiring layers of the chip. On the other hand, the second supply voltage VDD2 suffices with the required minimum impedance for feeding a current to any current consumption spot DVBR in spot fashion, and hence, the wiring layer thereof is designed as the required minimum mesh structure by employing the lower-layer metal wiring of the chip. This mesh structure should desirably be reinforced within the DVBR region.

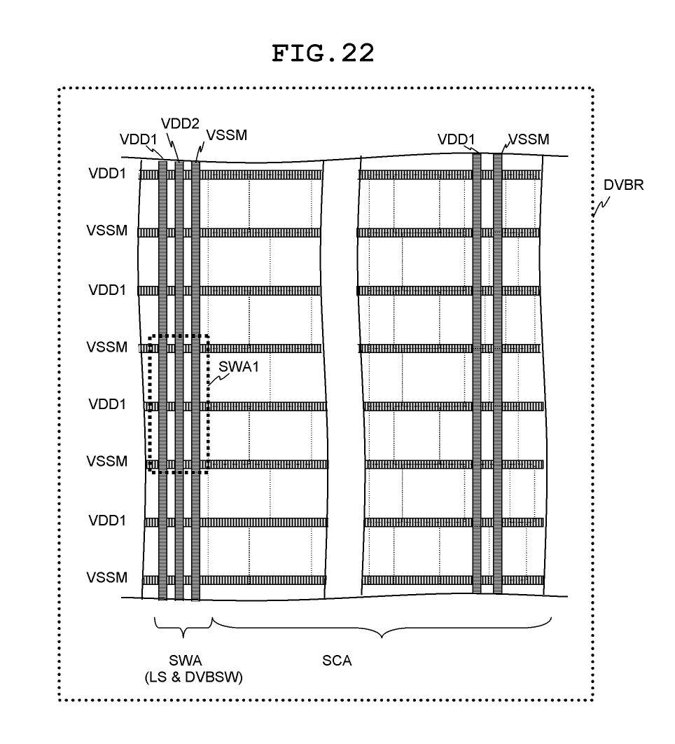

FIG. 22 shows the arrangement of the power source wiring lines of the DVBR region and standard cells constituting logic circuits.

The first supply voltage VDD1 and the virtual ground supply voltage VSSM have short basic intervals and assume rigid mesh structures, but the second supply voltage VDD2 is arranged at the required minimum intervals. An region where the first supply voltage VDD1, second supply voltage VDD2 and virtual ground supply voltage VSSM are vertically wired, is set as an region (SWA) where switches for connecting the second supply voltage VDD2 and the first supply voltage VDD1, and level shifters are integrated. Switch transistors which are integrated in the SWA region assume a configuration similar to that of the standard cell, and the switch transistor is integrated at a part at which the P-type MISFET of the standard cell is integrated. Here, the case of using the first metal wiring (M1) for the power feed of the cells and using the fourth metal wiring as trunk lines is supposed. A local mesh structure is configured of the first metal wiring and the fourth metal wiring. The transistors for connecting the first supply voltage VDD1 and the second supply voltage VDD2 are arranged in the region where the first supply voltage VDD1, second supply voltage VDD2 and virtual ground supply voltage VSSM are wired. On the other hand, switch transistors need not especially integrated in an region where the first supply voltage VDD1 and the virtual ground supply voltage VSSM are wired, and hence, the standard cells are spread all over this region in the same manner as in the other regions. Owing to such an arrangement, potential drops can be avoided with the increase of an area minimized.

The vertical wiring density of the second supply voltage VDD2 may be determined by the maximum current quantity for use in the logic circuits and the voltage value of the second supply voltage VDD2.

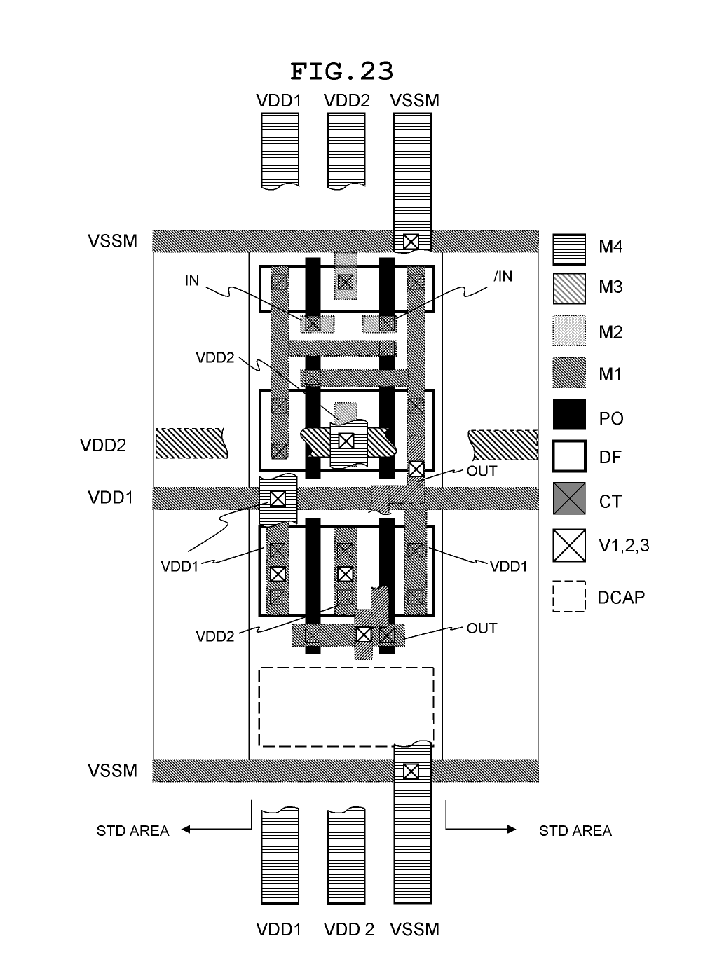

FIG. 23 shows on an enlarged scale, one SWA1 of the regions (SWA) where the switches for connecting the second supply voltage VDD2 and the first supply voltage VDD1, and the level shifters are integrated.

The two stages of the basic units of the standard cells held between the voltages VDD1 and VSSM are shown in FIG. 23. In this region, the voltages VDD1, VDD2 and VSSM are wired by the fourth metal wiring. The wiring layers M4 to M1 are connected through vias V3, V2 and V1. The voltages VDD1 and VSSM are connected through the vias at the intersection points between the first metal wiring M1 and the fourth metal wiring M4. Regarding the voltage VDD2, the metal wiring layers from the fourth metal wiring M4 to the third metal wiring M3 are wired through the vias V3, and to the underlying first metal wiring M1 are connected through the vias V1 and V2. This voltage VDD2 is inputted to the source of the P-type MISFET of the level shifter LS and the source of the P-type MISFET of the DVB switch. As the level shifter LS, the example in FIG. 13 is laid out. The level shifter LS and the DVB switch can be integrated under the vertical trunk lines of the voltages VDD1, VDD2 and VSSM. It is advantageous from the viewpoint of a stable operation to provide a region (region indicated as “DCAP”) where a decoupling capacitor can be added, in a remaining region (here, the region of an N-type MISFET). Regions on both the sides of the vertical trunk lines are standard cell regions where the ordinary logic circuits can be integrated.

As thus far stated, the second supply voltage VDD2 being usually higher than the supply voltage VDD1 is intermittently connected to the local current consumption spots within the LSI, whereby the voltage drops can be avoided. With this configuration, before the voltage drop arises, the supply voltage VDD1 can also be partly boosted and controlled to the very limit voltage of a transistor withstand voltage. In the mode of a so-called “high-load operation”, a high-speed performance is required, and it is therefore desirable to heighten a voltage to the utmost. The fluctuating range of a supply voltage is often defined as a certain range in specifications. The upper-limit voltage within the range ensures, of course, the withstand voltage of a MISFET, and it ensures normal logical operations (within the ranges of set-up and hold limitation). Accordingly, if the upper-limit voltage can be precisely sustained during the high-load operation, the sharp enhancement of the performance will be expected. Also in case of performing such a control, the ON/OFF switch of the P-type MISFET of a dynamic voltage boost control circuit may be controlled so as not to exceed the very limit voltage value of the withstand voltage while this limit voltage is being measured in interlocking with the ring oscillator type voltmeter which forms the main aspect of the invention. The performance of such a control brings forth the advantage that the lowest operating voltage for ensuring the high-speed operation of the logic circuit can be heightened in design, and that a high-speed operation SOC can be designed with ease. As another advantage, a voltage level can be precisely raised to the designed upper-limit value during the high-load operation, and the performance of the SOC can be enhanced to the utmost.

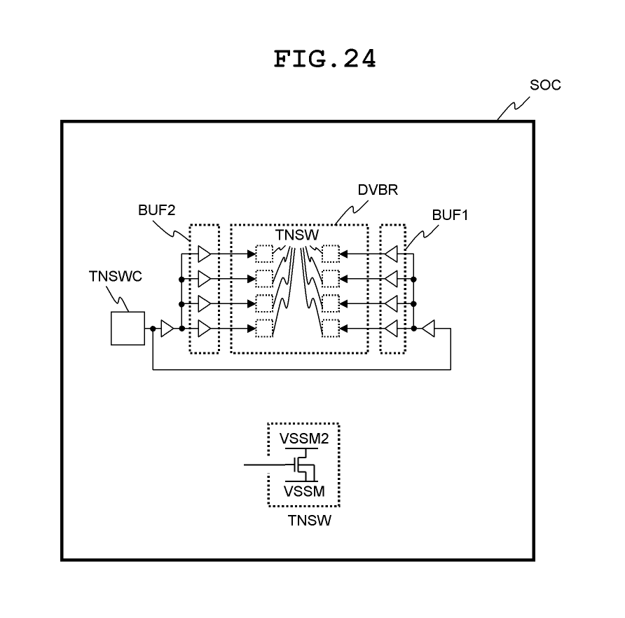

Meanwhile, a high-speed operation is important for the logic circuit for performing the supply voltage control disclosed in the invention, and hence, transistors constituting the logic circuit should desirably be made of transistors of so-called “low threshold voltages”. Since, however, such transistors undergo large leakage currents, the leakage currents should desirably be reduced by a subtle power source cutoff control. FIG. 24 shows a configurational example in the case where power source switches capable of the subtle power source cutoff control as stated above are conjointly employed. The figures shows the LSI, a circuit region (DVBR2) to which the voltage drop avoiding technique of the invention is applied is included within the LSI, and the power source cutoff switches are further disposed in the DVBR2 region. Each of the switches here is a switch which is configured of a transistor having the same film thickness as that of the transistor of the logic circuit. The interior of the LSI is basically operated by the supply voltage VDD1, and the virtual ground VSSM which is cutoff-controlled from the true ground (VSS) by the thick-film switch as shown in FIG. 1, whereas the DVBR2 region is operated by the first supply voltage VDD1, and the virtual ground VSSM2 which is cutoff-controlled from the virtual ground VSSM by the thin-film switch. Since this switch is operated by the potential of the first supply voltage VDD1, it can be controlled by a signal having a VDD1 amplitude. The control signal is controlled by a controller TNSWC. The control signal outputted from the controller TNSWC can be freely set within the LSI, likewise to the signal of the ordinary logic circuit, but it cannot be set in the DVBR2 region because the virtual ground is different. Accordingly, the drivers of the thin-film switches TNSW within the DVBR2 region are disposed in buffer regions (BUF1 and BUF2) outside the DVBR2 region.

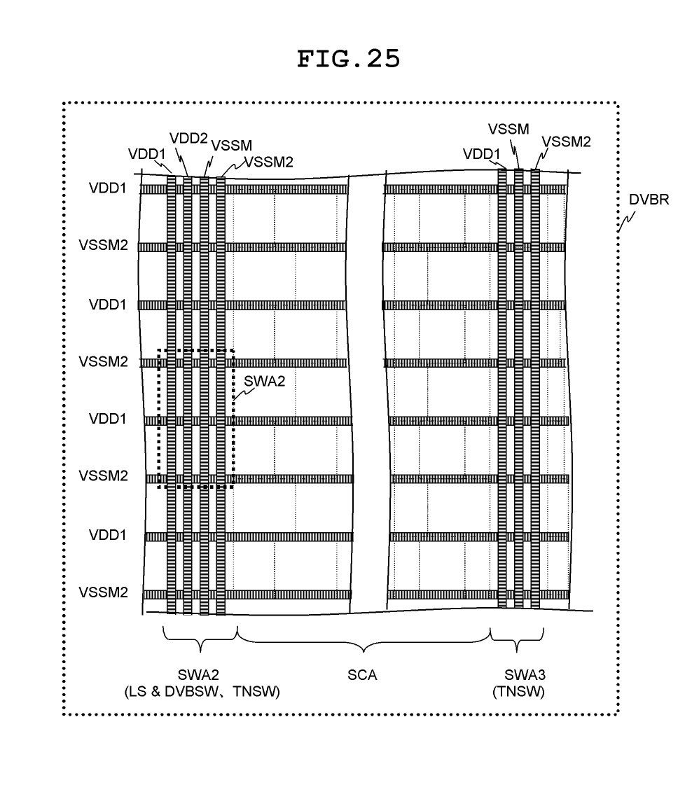

FIG. 25 shows a detailed configurational example of the DVBR portion in FIG. 24.

Here, the first supply voltage VDD1, second supply voltage VDD2, and virtual ground supply voltages VSSM and VSSM2 are laid out as vertical power-source trunk lines, while the first supply voltage VDD1 and virtual ground supply voltage VSSM2 are laid out in a lateral direction. Regarding the second supply voltage VDD2, the current feed quantity is auxiliary, and the voltage is high, as stated before. Therefore, this voltage VDD2 can also be laid out by decreasing the number of layout lines. Since logic cells are arrayed in the lateral direction, the arrayal direction of the second supply voltage VDD2 is orthogonal to that of the logic cells. In such an arrayal region of the second supply voltage VDD2, there are integrated the switches for connecting the first supply voltage VDD1 and the second supply voltage VDD2, the level shifters for controlling the switches, and the thin-film switches. In a region where the second supply voltage VDD2 is not wired, only the thin-film switches (TNSW) are integrated.

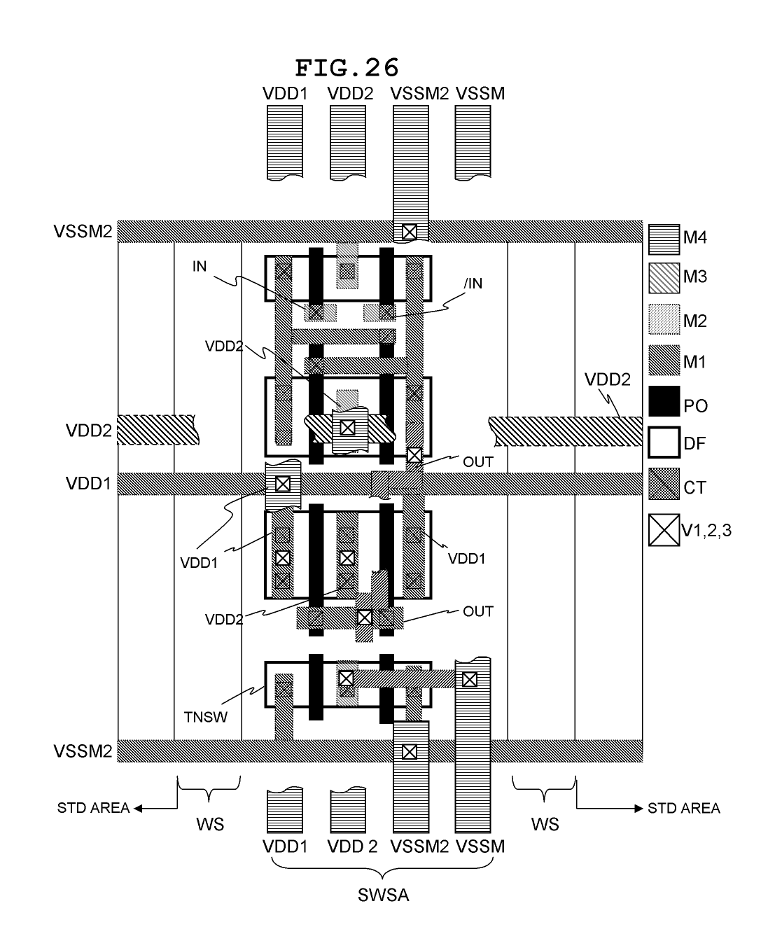

FIG. 26 shows on an enlarged scale, the principal portions of SWA regions shown in FIG. 25.

Here, the two stages of the basic units of the standard cells held between the voltages VDD1 and VSSM2 are shown. In this region, the voltages VDD1, VDD2, VSSM and VSSM2 are wired by the fourth metal wiring. The wiring layers M4 to M1 are connected through vias V3, V2 and V1. The voltages VDD1 and VSSM2 are connected through the vias at the intersection points between the first metal wiring M1 and the fourth metal wiring M4. The level shifters LS, DVB switches and thin-film switches can be integrated under the vertical trunk lines of the voltages VDD1, VDD2, VSSM and VSSM2. Regarding the voltage VDD2, the metal wiring layers from the fourth metal wiring M4 to the third metal wiring M3 are wired through the vias V3 and are extended in a lateral direction in the figure. Further, the metal wiring layers to the underlying first metal wiring M1 are connected through the vias V1 and V2. This voltage VDD2 is inputted to the source of the P-type MISFET of the level shifter LS and the source of the P-type MISFET of the DVB switch. As the level shifter LS, the example in FIG. 13 is laid out. Besides, the VSSM wiring from the wiring layer M4 to the wiring layer M1 are connected by the vias so as to lead to the source parts of the thin-film switches. Regions on both the sides of the vertical trunk lines are standard cell regions where the ordinary logic circuits can be integrated. In a place where these supply voltages are vertically wired, the substrate electrodes of N-type MISFETs should desirably be isolated in the case of employing the thin-film switches. In that case, an SWSA region where the level shifters LS, DVB switches and thin-film switches are integrated need to be connected with the standard cell regions through well separation regions WS. In case of adopting a triple well configuration, the substrate potential isolation of the N-type MISFETs can be realized merely by holding an N-type well between P-type wells, so that the increase of an area can be avoided. Moreover, the P-type MISFETs can be integrated in the N-type well region. Therefore, when the switch transistors for connecting the first supply voltage VDD1 and the second supply voltage VDD2 are integrated in this region, a total gate width can be gained, and the increase of a current feed capability can be attained.

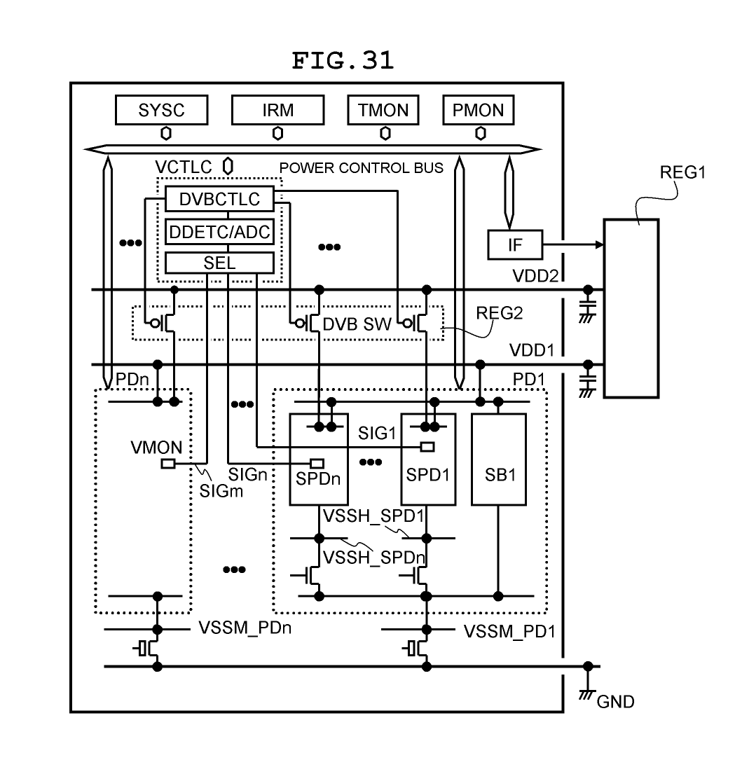

The above scheme has the advantage that the area can be made small in a case where the supply voltage VDD2 is limitatively applied to a certain power source region. Here will be stated an example in the case where the supply voltage VDD2 is shared by the plurality of blocks of the whole chip. FIG. 31 exemplifies a configuration in the case where the power source region within the LSI is multi-divided. A functional block SB within the LSI corresponds to each power source region PD which uses the supply voltage VDD1, and a virtual ground VSSM_PD connected to the ground GND through a thick-film switch and in which several functional blocks are collected, and a plurality of such functional blocks SB are integrated. Each region PD is subdivided into respective functional blocks, some of which are further integrated as sub power source regions SPD that are connected to a host virtual ground VSSH isolated from the virtual ground VSSM_PD through thin-film switches. The performance and non-performance of the on-chip supply voltage control are made by selectively ON/OFF-controlling a DVB switch every functional block. Here will be illustrated an example in which the DVB switch controls of the plurality of power source regions within the chip are performed by the identical supply voltage VDD2. The on-chip supply voltage control is performed by an on-chip voltage control circuit VCTLC. The circuit VCTLC collects voltage information items from the respective functional blocks, and it performs the voltage controls of the respective functional blocks in accordance with control information received from a host control system IRM through a power control bus. The system IRM conveys the control information to the circuit VCTLC by using several monitors (temperature sensor TMON and process monitor PMON) and activation information items collected from the respective functional blocks. The supply voltages to be fed into the chip are controlled by controlling an off-chip regulator through an on-chip interface circuit IF which is connected through the power control bus.

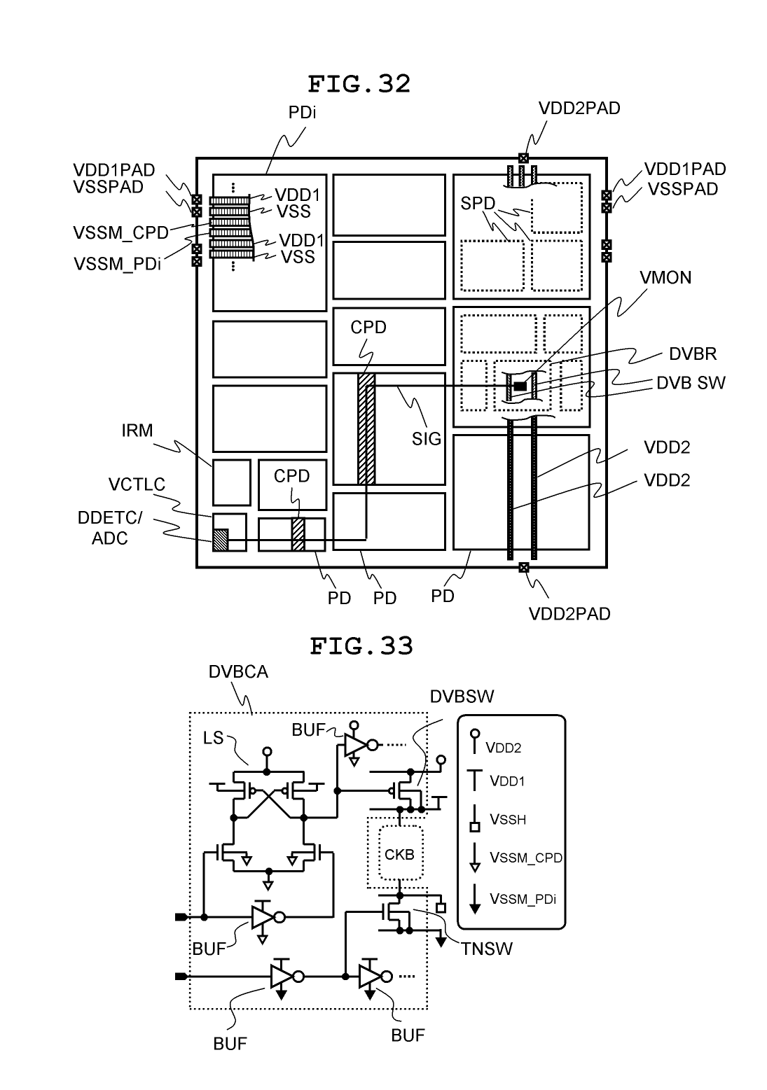

FIG. 32 exemplifies an integration method in the case where the power source region within the SoC is multi-divided. A plurality of power source regions PD are integrated within the chip, and some of them are further configured as sub power source regions (SPD) through thin-film switches. Power source wiring is such that global supply voltage lines VDD1, VSS and VSSM_CPD, and a local virtual supply voltage line VSSM_PDi laid in the power source region are laid at the uppermost layer. The supply voltage VSSM_PDi is the virtual ground of the power source region i (PDi). Here is illustrated an example in which the virtual ground VSSM_PDi is laid in the lateral direction of the chip (in a direction parallel to the cell row of a standard cell). Among the supply voltages, the supply voltages VDD1 and VSS which are fed from outside the chip are fed from the right and left sides of the chip by using pluralities of power source pads VDDPAD and VSSPAD. The supply voltage VDD2 should desirably be arranged concentratively in places where the on-chip power source controls are performed. Here is illustrated an example in which, considering the fact that the supply voltage VDD2 line can be laid with a high resistance as compared with the resistances of the other global supply voltage lines, at least one supply voltage feed pad VDD2PAD is arranged at each of the upper and lower sides of the chip, so as to feed the supply voltage VDD2 from the pads. Premising that the high resistance is allowed, it is supposed that the VDD2 lines within the chip are laid in the vertical direction of the chip by a lower wiring layer which is not the uppermost layer. An on-chip power source control circuit VCTLC is integrated at the peripheral edge part of the chip, and it acquires voltage information signals MONIOUT being on-chip voltmeter output signals from a plurality of voltage control blocks and transmits voltage control signals MONIE being the on-chip voltmeter enable signals of the blocks. These signals are collectively indicated as SIG (SIG1-SIGn and SIGm) in order to avoid complicacy. Besides, when the plurality of signals SIG are conveyed to the circuit VCTLC through the selectors as shown in FIG. 12, the advantage of reducing an area is attained. The voltage information is measured by a voltage measurement circuit VMON which is integrated within the voltage control block. The voltage control circuit digitizes frequency information transmitted from the voltage measurement circuit VMON, thereby to convert the frequency information into the voltage information. The control circuit VCTLC is controlled by a resource management circuit IRM within the LSI. A common power source region CPD is used for relaying the conveyances of the control signals MONIE and MONIOUT. The region CPD is a region which continues to be energized even when the supply voltages of the surrounding power source regions are cut off. Thus, the signals can be conveyed even in a case where the supply voltages of functional blocks which are passed to blocks to-be-controlled are cut off. If necessary, the voltage monitor signal from the voltage control block to the voltage control unit may well be conveyed while being buffered and relayed by the common power source region CPD. In this manner, in the case where the power source region is multi-divided, it is preferable that, whereas the voltage measurement circuits VMON are disposed in the respective divisional power source regions, the on-chip supply voltage control circuit (VCTLC) is arranged at the peripheral edge part of the chip as the single circuit for the reasons of reducing an area and stabilizing the power source of the VCTLC circuit. In this case, the relaying circuits of the control signals SIG (including the signals MONIE and MONIOUT) are wired using the common power source region CPD, whereby the power source control circuit and the voltage measurement circuit can be connected.

FIG. 33 is a block diagram showing a DVB switch DVBSW, a level shifter LS, a thin-film switch TNSW and buffer circuits BUF which serve to control the power source of a voltage control block DVBR in FIG. 32. These constituents are collectively integrated in a DVB switch control region DVBCA as will be stated later. The substrate and source voltages of an NMOS constituting the thin-film switch TNSW are connected to the virtual ground line VSSM_PDi of the power source region PDi, and the substrate and source potentials of a PMOS constituting the DVB switch are connected to the supply voltage VDD1. This is premised on the fact that the thin-film switches are controlled by the circuit of the power source region PDi including the sub power source regions to-be-controlled. On the other hand, regarding the circuit for controlling the DVB switch, it is convenient to employ the virtual ground of the common power source region CPD as the substrate and supply voltages of the NMOS. The reason therefor is that, even when the power source of the power source region PDi where the DVB switch is integrated is cut off, this DVB switch needs to be kept OFF.

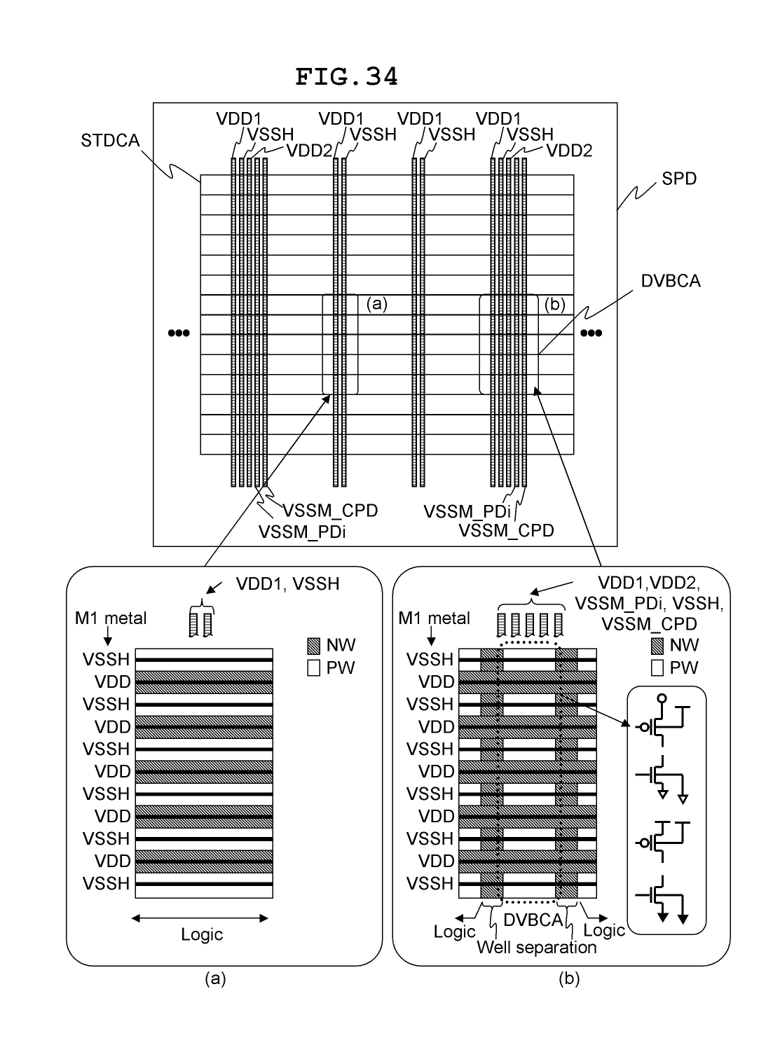

FIG. 34 shows a layout example of the circuits in FIG. 33. In the case of the circuit scheme in FIG. 33, supply voltages required by logic circuits within the sub power source regions are the voltages VDD1 and VSSH, and supply voltages required by circuits for controlling the DVB switch and the thin-film switch are the voltages VDD1, VDD2, VSSM_CPD and VSSM_PDi. Therefore, the local meshes of the power source are formed by the voltages VDD1 and VSSH, and the lines of the voltages VDD2, VSSM_CPD and VSSM_PDi are wired in places where the DVB switch and the thin-film switch are disposed.

Lower diagrams show enlarged views of a region (a) where the vertical trunk lines of the supply voltages VDD1 and VSSH are wired, and a region (b) where the lines of the voltages VDD1, VDD2, VSSH, VSSM_CPD and VSSM_PDi are wired. The lines of the voltages VDD1 and VSSH are wired at regular intervals within the chip, and the interval shall be called the basic grating unit of the vertical trunk lines of the power source meshes of the voltages VDD1 and VSSH″ below. In the region where the vertical trunk lines of the supply voltages VDD1 and VSSH run, the substrate and source of a PMOS in an ordinary logic circuit are fed with the voltage VDD, and the substrate and source of an NMOS are fed with the voltage VSSH. The local power source lines wired in a lateral direction are power source lines belonging to a cell, and they are wired using the lowermost metal layer (Ml). When contacts are provided in places where the vertical power source trunk lines and the lateral power source lines cross, the power source meshes are formed. On the other hand, in the region where the lines of the voltages VDD1, VDD2, VSSH, VSSM_CPD and VSSM_PDi run, well separation based on NWELL (N-type well regions) is performed thereunder in order to isolate the substrate of the NMOS, whereby insular areas are created. Since the substrate of the PMOS uses the supply voltage VDD1, well separation is unnecessary. The NMOS region shares PWELL (P-type well region) surrounded with two stages of standard cells, by the NMOS of the same substrate, and the number of constituent stages may be changed and designed in need in such units.

The reason therefor is that, when the local meshes of the supply voltages VDD1 and VSSH are firmly formed, the sizes of the DVB switch and the thin-film switch can be made small. Further, owing to the adoption of this scheme, the well separation regions can be minimized. Of course, in a case where the increase of an area is not cared about as the whole chip for such a reason that the voltage control region is relatively small, this structure can be applied to all the basic mesh grating units of the voltages VDD1 and VSSH in order to integrate the maximum switch size.

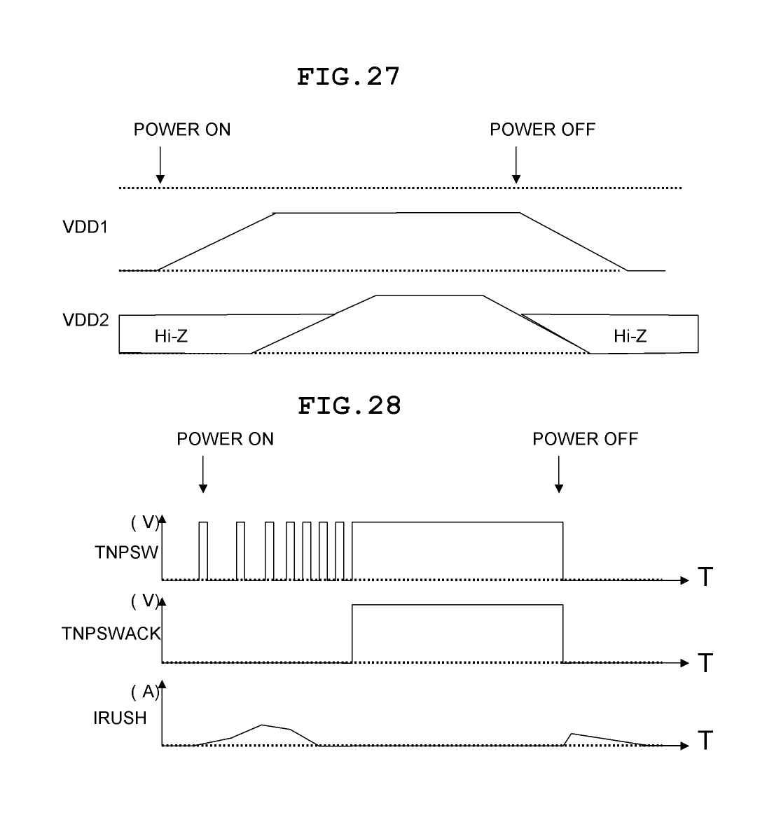

FIG. 27 shows the application procedure of the first supply voltage VDD1 and the second supply voltage VDD2 in the case where the above power source scheme is employed.

In this example, a mechanism for connecting the first supply voltage VDD1 and the second supply voltage VDD2 is disposed, and hence, a supply voltage control in a power-ON mode is necessitated. Here, the first supply voltage VDD1 is first asserted, and the second supply voltage VDD2 is applied. On this occasion, the second supply voltage VDD2 is brought into a high impedance state. Thus, even when the second supply voltage VDD2 which is the power source of the switch for connecting the first supply voltage VDD1 and the second supply voltage VDD2, and the level shifter, is not turned ON, the malfunction of the circuit arrangement is avoided merely by charging capacitors added to the trunk line of the second supply voltage VDD2 and a printed circuit board, to the level of at most the voltage VDD1. Upon judging that the first power source VDD1 has outputted a rated value, the second supply voltage VDD2 is applied. In this way, the first supply voltage VDD1 and the second supply voltage VDD2 can be applied to the LSI. It is also avoidable that the supply voltage VDD2 is turned ON earlier in the process of power source closure, with the result that the withstand voltage limit of the transistor is exceeded. By the way, in the case where the second supply voltage VDD2 has been applied, the internal logic circuit is permitted to operate. Accordingly, the control of the switch for connecting the second supply voltage VDD2 and the first supply voltage VDD1 becomes possible. On this occasion, when a control for turning OFF the switch is performed, the internal logic circuit operates with only the first supply voltage VDD1, so that a more stable operation becomes possible.

FIG. 28 shows a timing example in the case where the thin-film switch is controlled in the LSI chip SOC.

In turning ON the power source switch, a rush current (IRUSH) must be cared for. It is known that, when the power source switch is turned ON with force, large quantities of rush currents (1 RUSH) flow. In a case where the power source switch is turned ON during the operation of the LSI, the suppression of the rush currents IRUSH is necessary. In order to suppress the rush currents (1 RUSH), the ON/OFF controls of the switch are intermittently performed. The rush currents IRUSH can be precisely controlled when they are controlled while monitoring the situation thereof by the voltage measurement circuit VMON, etc. When the power source switch has fallen into its ON state, an acknowledge signal (TNPSWACK) is brought to the high (H) level, thereby to notify the ON state of the switch to the system controller.

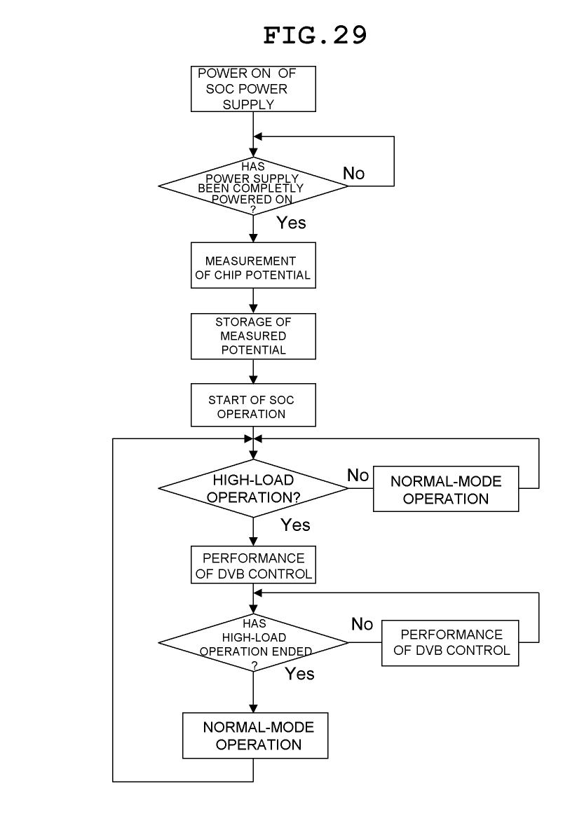

FIG. 29 shows an operating flow in the case where the voltage control is performed in the LSI chip SOC.

First, the power source of the LSI chip SOC is closed, and if the power source has been stabilized is decided. The internal voltmeter may be employed for the decision of the stabilization. Alternatively, the stabilization of the power source can be decided in such a way that the system controller grasps the stabilization by means for temporal measurement or the like, and that it transmits a voltage guarantee signal after having waited till the sufficient stabilization of the supply voltage of the power source. After the supply voltage of the power source of the LSI chip SOC has been asserted, the potential of the LSI chip SOC is measured. On this occasion, clock distribution and a process such as the calculation of the logic block should desirably be kept OFF. This is because the output voltage value of an off-chip power source circuit can be considered substantially equal to a voltage value within the chip. Thereafter, voltage information measured here is stored in a latch circuit, a register, or the like in order to be used as a reference in the performance of the DVB control. According to the main embodiment of the invention, the voltage information is the cycle information of the ring oscillator. Thereafter, the operation of the LSI chip SOC is started. The LSI chip SOC differs in a frequency and a calculation load, depending upon an application which is to be run. Especially in a case where the maximum performance is required, the frequency is heightened, and the activation rate of calculations is heightened, so that a large quantity of current is consumed. In such a high-load operation mode, the influence of a voltage drop is apprehended, and hence, the DVB control should desirably be performed. Accordingly, when the high-load operation has been judged, a control for turning ON the DVB control is performed. From the viewpoint of low consumption power, it is important that the DVB control is held quiescent in any other mode than the high-load operation. Therefore, in a case where the high-load operation has ended, the LSI chip SOC is brought into a normal-mode operation in which the DVB control is not performed, and the DVB control is held quiescent till the high-load operation of the next time. If the high-load operation is executed, is conveniently known at the changeover of applications. The reason therefor is as stated below. In a case, for example, where a dedicated hardware accelerator for which the high-load operation is anticipated is used, the DVB control can be turned ON in interlocking with the use of the hardware accelerator. Besides, in some of the applications, there is considered such a control that the height of the load is grasped by an operating system (OS), and that a control bit for performing the DVB control is set at the changeover of the applications through middleware or the like.

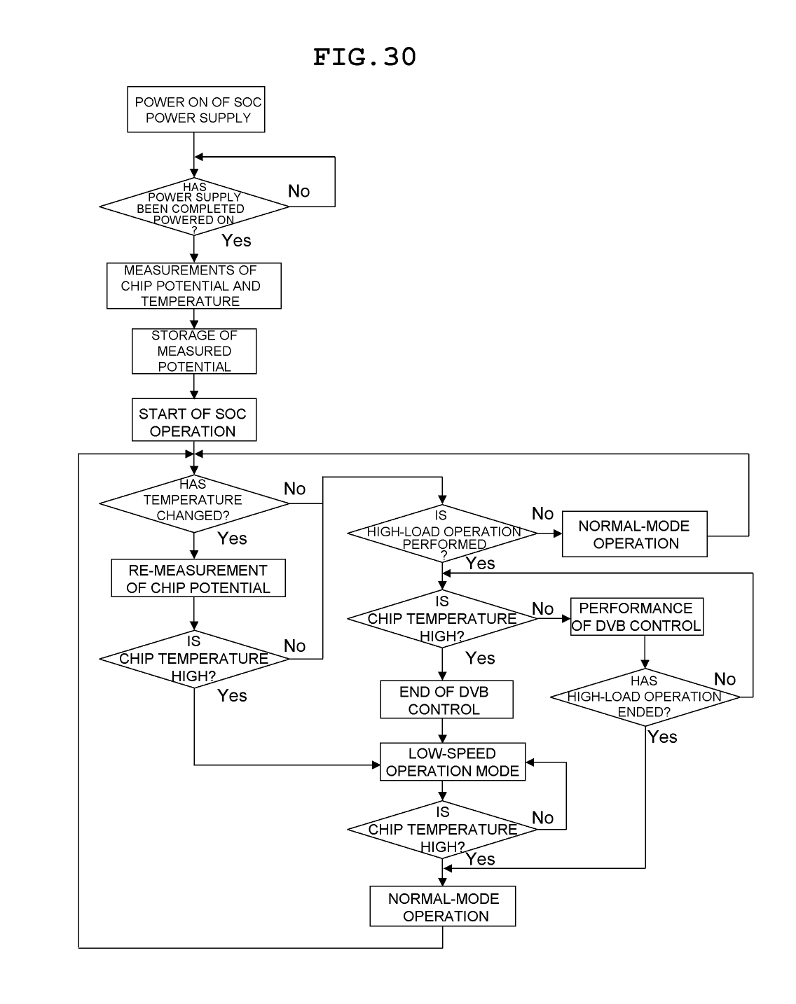

FIG. 30 shows an operating flow in the case where the voltage control is performed in the LSI chip SOC.

As in the case shown in FIG. 29, the power source of the LSI chip SOC is first closed, and if the power source has been stabilized is decided. The internal voltmeter may be employed for the decision of the stabilization. Alternatively, the stabilization of the power source can be decided in such a way that the system controller grasps the stabilization by means for temporal measurement or the like, and that it transmits a voltage guarantee signal after having waited till the sufficient stabilization of the supply voltage of the power source. After the supply voltage of the power source of the LSI chip SOC has been asserted, the potential and temperature of the LSI chip SOC are measured. On this occasion, clock distribution and a process such as the calculation of the logic block should desirably be kept OFF. Regarding the voltage measurement, as in the case of FIG. 29, voltage information measured here is stored in a latch circuit, a register, or the like in order to be used as a reference in the performance of the DVB control. According to the main embodiment of the invention, the voltage information is the cycle information of the ring oscillator. On the other hand, regarding the temperature measurement, the temperature of the chip is measured by, for example, a method for measuring the temperature characteristic of a band-gap generator or a diode, and the measured value is retained in a register or the like circuit. After the potential and temperature of the chip have been measured, the operation of the SoC is started. The temperature of the chip changes during use on account of the change of an environmental temperature, a temperature rise ascribable to the SoC operation, or the like. In the voltage measurement based on the ring oscillator, a voltage measurement error ascribable to the temperature is apprehended. Therefore, when the temperature has changed, it is desirable that the chip voltage is measured again so as to update the value of the latch or register. Thereafter, in a case where the chip enters a high-load operation in that temperature state, the DVB control should desirably be performed subject to the condition that the chip temperature is not high. In a case where the DVB control is being performed, the continuation or stop of the DVB control is controlled in consideration of a high-load-state continuation request and a chip temperature rise situation. In a case where the DVB control has been forcibly ended, the operation of the chip should desirably be changed-over to a low-speed operation mode in order to cool the chip. Thereafter, the temperature change is measured, and when the chip has been sufficiently cooled, the operation is shifted into a normal mode again, and the DVB control may be performed in need.

Although the practicable embodiments of the invention have been described above, it is needless to say that the invention is not restricted to the foregoing embodiments, but that it is variously alterable within a scope not departing from the purport thereof.

By way of example, in FIGS. 5 and 6, the control of the on-chip regulator REG2 is performed separately for the voltage measurement period and the voltage control period, thereby to permit the high-precision and high-speed control of the on-chip regulator REG2. This is effective for a temporally-short supply voltage drop at a hot spot. However, in a case where current consumption in a circuit continues constantly, it is sometimes effective that a voltage control is performed for a fixed period while a voltage is being detected every time. This is also intended to reduce a current which is consumed for the control of the regulator REG2. In this case, it is convenient to end the operation of the regulator REG2 in agreement with the detection of a certain threshold voltage in the voltage measurement. In a case, for example, the voltage control has been started at 50 mV, it is stopped in a case where a voltage difference of 10 mV has been detected. In the case where the voltage control is performed with a hysteresis in this manner, there is the advantage that, even when a high-load operation continues for long, surplus REG2 changeover operations become unnecessary, so power consumption is lowered still further. In the case where the voltage control is performed for the certain fixed period in this manner, a control corresponding to the operating situation of the LSI, not the control based on the measured result of the voltmeter, is also possible. By way of example, it is also possible to control the on-chip regulator REG2 in accordance with the changeover of a clock frequency, or to control the regulator REG2 in agreement with the start and stop of a certain specified hardware accelerator integrated in the LSI. Even in this case, it is advantageous for voltage drop reduction and power consumption reduction that the voltage is always monitored, and that a control for changing-over the drivability of the regulator REG2 is performed as may be needed.

Although, in the above, the invention has been chiefly described as to the case of the application to the LSI chip SOC forming the technical background of the invention, the invention is not restricted thereto, but it is extensively applicable to various semiconductor integrated circuits.

What is claimed is:

1. A semiconductor integrated circuit comprising:
a first power source wiring line supplying a first supply voltage;
a logic circuit block which is operable by being supplied with the first supply voltage;
a second power source wiring line supplying a second supply voltage which is higher in level than the first supply voltage;
a switch which is capable of connecting the first power source wiring line and the second power source wiring line; and
a control circuit controls said switch when the first supply voltage has undergone a potential drop, so as to intermittently connect said second power source wiring line to said first power source wiring line.

2. A semiconductor integrated circuit according to claim 1, further comprising
a voltage measurement circuit which is capable of measuring a fluctuation of the first supply voltage,
wherein said control circuit controls said switch in accordance with a measured result in said voltage measurement circuit.

3. A semiconductor integrated circuit according to claim 2,
wherein said voltage measurement circuit comprises:
a ring oscillator which is capable of converting voltage information into oscillation cycle information; and
an analog/digital conversion circuit which converts the oscillation cycle information of said ring oscillator into a digital signal; and
wherein said second power source wiring line is intermittently connected to said first power source wiring line in accordance with the output signal of said analog/digital conversion circuit.

4. A semiconductor integrated circuit according to claim 1,
wherein when the first supply voltage and the second supply voltage are supplied from a voltage feed circuit which is provided at outside said semiconductor integrated circuit, a time constant of the control in the case of intermittently connecting said second power source wiring line to said first power source wiring line is set to be smaller than a voltage-control time constant of said voltage feed circuit.

5. A semiconductor integrated circuit according to claim 1, wherein said switch comprises a MISFET.

6. A semiconductor integrated circuit according to claim 5,
wherein said MISFET is intermittently rendered conductive in a case where the output signal of said analog/digital conversion circuit is larger than a preset voltage fluctuation magnitude.

7. A semiconductor integrated circuit according to claim 1,
wherein said switch comprises MISFETs which are divided into a plurality of groups, and reference levels which are different from one another are set for the respective groups, whereby the intermittent connections between said second power source wiring line and said first power source wiring line are controlled in units of the groups.

8. A semiconductor integrated circuit according to claim 1,
wherein said control circuit comprises the same sort of MISFET as a MISFET constituting said logic circuit block.

9. A semiconductor integrated circuit according to claim 1,
wherein all MISFETs constituting said control circuit are the same sort of MISFETs as MISFETs constituting said logic circuit block.

10. A semiconductor integrated circuit according to claim 1,
wherein said control circuit comprises a MISFET which is different in a gate insulating film thickness from a MISFET constituting said logic circuit block.

11. A semiconductor integrated circuit according to claim 1, further comprising
a thermometer which is capable of measuring a temperature within said semiconductor integrated circuit,
wherein the control by said control circuit is limited on the basis of a measured result of said thermometer.

12. A semiconductor integrated circuit according to claim 11,
wherein the control by said control circuit is not performed in a case where the measured result of said thermometer exceeds a predetermined level.

13. A semiconductor integrated circuit according to claim 1,
wherein said first power source wiring line is lower in impedance than said second power source wiring line and is connected using a large number of wiring lines, and said second power source wiring line is wired with the number of wiring lines smaller than the number of the wiring lines of said first power source wiring line.

14. A semiconductor integrated circuit according to claim 3, further comprising:
a digital filter which executes a filtering process of the output signal of said analog/digital conversion circuit.

15. A semiconductor integrated circuit according to claim 1,
wherein when said first power source wiring line and said second power source wiring line are arrayed in a direction orthogonal to an arrayal direction of logic cells, said switch is integrated in an arrayed region of said first power source wiring line and said second power source wiring line.

16. A semiconductor integrated circuit according to claim 1,
wherein said switch is driven by a pulse-shaped signal, and a pulse width and a pulse interval of the pulse-shaped signal are controlled by said control circuit.

17. A semiconductor integrated circuit according to claim 2,
wherein said semiconductor integrated circuit is separated into a plurality of power source regions which can be controlled independently of one another as to whether or not feed of an operating voltage is cut off,
wherein said plurality of power source regions has a common power source region which is energized even in a case where the feed of the operating voltage is controlled so as to be cut off,
wherein the voltage measurement circuits are respectively arranged in said plurality of power source regions,
wherein the control circuits are collectively arranged in a region which is different from said plurality of power source regions, and
wherein signals which are transferred between said control circuits and said voltage measurement circuits are transferred through said common power source region of said plurality of power source regions.
